(19) United States
(12) Patent Application Publication
(10) Pub. No.: US 2024/0164261 A1
(43) Pub. Date: May 23, 2024

(54) Methods and Apparatus for Bio-Regulation and Templating of Plant Growth Within a Controlled Growth Capsule for the Production of Augmented Bio-Consumables

(71) Applicant: Neox Public Benefit LLC, New York, NY (US)

(72) Inventor: Neri OXMAN, New York, NY (US)

(21) Appl. No.: 18/548,511

(22) PCT Filed: Mar. 2, 2022
(86) PCT No.: PCT/US2022/018525

§ 371 Date: Aug. 31, 2023

Related U.S. Application Data
(60) Provisional application No. 63/156,116, filed on Mar. 3, 2021.
(60) Provisional application No. 63/156,099, filed on Mar. 3, 2021.

(51) Int. Cl. A01G 9/26; A01G 9/02; A01G 9/14; G06N 20/00

(52) U.S. Cl. CPC A01G 9/26; A01G 9/02; A01G 9/143; G06N 20/00

(57) ABSTRACT

Systems and methods for regulating growth of an organism. One aspect relates to a an environmental growth capsule which includes an “intelligent skin” infrastructure and growth capsules called biovoxels for the purposes of controlled variation of environmental parameters. Each biovoxel surrounds at least one growing biological material or organism, such as a plant or other biological organism and may contain appropriate growth media, such as soil, positioned in a hybrid plant product template. Further, in one aspect, at least one sensor monitors at least one environmental condition in each biovoxel and outputs sensed signals: and at least one actuator is actuated in response to actuation signals provided from a processor. The processor receives the sensed signals and outputs the actuation signals to change the at least one environmental condition. The capsule may be enabled with artificial intelligence.

This application claims the priority benefit of U.S. provisional patent applications nos. 63/156,099 and 63/156,116, both filed on Mar. 3, 2021. The contents of these applications are incorporated in their entirety herein by reference in toto.

### FIELD OF THE INVENTION

The present invention relates generally to regulation of the growth of biological material or organisms, such as plants, by combining environmental templating with gene expression regulation (such as light which can induce reprogramming of gene expression in plants) for purposes of design and construction of bio-augmented or bio-consumable products, including engineered hybrid plant products, as well as systems for preparing such bio-augmented or bio-consumable products.

### BACKGROUND OF THE INVENTION

To grow a bio-consumable product in a laboratory environment, there is a need for it to be manufactured in a manner that allows multiple products to form in three-dimensions within an infrastructure. There is a need for an improved 3D infrastructure that allows for the highly tunable differentiation of microenvironmental conditions across a 3D “garden” of bio-augmented products, facilitating an extremely high number of controllable and/or autonomous artificial intelligence led (Al-led) spatiotemporal growing scenarios. Thus, there is a need for an environmental-controlled growth chamber configured to enable programmable variation of environmental conditions between different locations within the chamber, rather than a growth chamber having a relatively homogeneous environmental conditions in which a measurement of environmental conditions at any location within the environment is the same throughout as in conventional systems. There is also a need for a growth chamber comprising a plurality of individual self-contained growing microenvironments, where the environmental parameters within each microenvironment may be independently and individually controlled (i.e., controlled variation between different locations within the chamber).

### SUMMARY OF THE INVENTION

The system, device, method, arrangement, user interface, computer program, processes of the present invention address problems in prior art systems. The present invention addresses the problem of manufacturing bioconsumable products in a laboratory setting. The bioconsumable product referred to herein as a hybrid plant product (HPP) is a plant-based construct such as a textile, a building material or finished apparel that has been grown in a laboratory environment. A hybrid plant-based product template (HPPT) is a material and/or environmental volume on or in which the HPP is grown.

One aspect of the present invention is directed to an environmental growth capsule which includes an “intelligent skin” infrastructure and one or more growth environments (termed “biovoxels”) operationally coupled to the capsule for the purposes of controlled variation of environmental parameters. Each biovoxel may be surrounded by its own intelligent skin infrastructure such that the environmental parameters within each biovoxel may be individually and independently controlled, resulting in a controlled variation of environmental parameters at any given point within the 3D volume of the capsule. Each biovoxel contains a growing biological material or organism and may contain growth media. Further, a sensor monitors at least one environmental condition in each biovoxel and outputs sensed signals; and at least one actuator is actuated in response to actuation signals provided from a processor.

The actuation signals may be provided by artificial intelligence via a feedback or machine learning loop, or the actuator signals may be provided by a researcher or other user. The artificial intelligence may provide other kinds of signals or may adjust any of the parameters or steps in accordance with the invention to facilitate growth of a biological organism.

One embodiment of this aspect of the present invention is a system for regulating growth of an organism. The system may comprise a growth capsule; one or more biovoxels located in the growth capsule, each biovoxel being configured to contain the organism and to include material for the growth of the organism; at least one sensor configured to monitor at least one environmental condition in each biovoxel and output sensed signals; at least one actuator configured to be actuated in response to actuation signals; and a processor configured to receive the sensed signals and output the actuation signals to actuate the at least one actuator to change the at least one environmental condition in response to the sensed signals.

Another embodiment of this aspect of the invention is a method for regulating growth of an organism. The method may comprise the steps of: providing biovoxels in a growth capsule, each biovoxel being configured to surround the organism and to include material for the growth of the organism; monitoring at least one environmental condition in each biovoxel by at least one sensor configured to output sensed signals; providing at least one actuator; receiving the sensed signals by a processor; and providing to the at least one actuator actuation signals by the processor to actuate the at least one actuator to change the at least one environmental condition in response to the sensed signals.

Another embodiment of this aspect of the present invention is a non-transitory computer readable medium storing computer instructions, which when executed by a processor, configure the processor to perform a method for regulating growth of an organism, the method comprising steps of: providing biovoxels in a growth capsule, each biovoxel being configured to surround the organism and to include material for the growth of the organism; monitoring at least one environmental condition in each biovoxel by at least one sensor configured to output sensed signals; providing at least one actuator; receiving the sensed signals by a processor; and providing to the at least one actuator actuation signals by the processor to actuate the at least one actuator to change the at least one environmental condition in response to the sensed signals.

In certain embodiments, the invention may yield a material that is part-natural and part manufactured, a kind of smart hybrid living material. In other embodiments, the invention may yield a building material that functions as both structural support and programmable interface. In certain embodiments, the invention gradually and continually adapts to its environment, and certain bio-consumable products such as hybrid plant products do not generate waste but rather decay when their lifespan ends. In this manner, the end product may be designed with both material emergence and decay in mind in order to minimize the impact of the bio-consumable product on the environment.

### BRIEF DESCRIPTION OF THE DRAWINGS

The present invention is explained in further detail in the following exemplary embodiments with reference to the figures, where the features of the various exemplary embodiments are combinable. The embodiments of the invention are discussed and explained below with reference to the accompanying drawings. It is to be understood that the drawings are provided as an exemplary understanding of the invention and to schematically illustrate particular embodiments of the invention. The skilled artisan will readily recognize other similar examples that are equally within the scope of the invention. The drawings are not intended to limit the scope of the invention as defined in the appended claims.

FIG. 1 shows a 3D printer setup showing a printer having a movable arm and an injector which are under the control of a processor for control of flow of material into a hydrogel cube.

FIG. 2 shows a 3D printer printing black pigment into a hydrogel.

FIG. 3A shows a hydrogel infused with a first pattern of black pigment, where FIG. 3B shows the first pattern of black pigment in greater detail.

FIGS. 4A and 4B show a hydrogel infused with a second pattern of black pigment.

FIGS. 5A and 5B show top and side views, respectively, of a propylene glycol carrying spirulina as a pigment, deposited by an injector in a zig zag pattern.

FIG. 6A shows extruding agar with food coloring from an injector. FIG. 6B shows extruding water into hydrogel deposited from an injector.

FIGS. 7 and 8 show extruding propylene glycol carrying dissolved food coloring pigment, deposited from an injector in a zig zag pattern.

FIG. 9 shows extruding dyed glycerin from an injector printed without a substrate with calibrated negative pressure.

FIGS. 10A-10D show an exemplary semi-rigid scaffold for a shoe sole which is 3D printed in a multicellular geometry.

FIGS. 11A-11D show embodiments of a capsule according to the invention in which the intelligent skin or walls are provisioned with various infrastructure services which are independently controlled.

FIG. 12 shows an environmental pixel that is representative of a portion of an intelligent skin of a capsule or a biovoxel surrounding a growing organism such as a plant.

FIG. 13 shows a seed bank in which a cell wall includes a plurality of propagative plant structures or seeds arranged in a matrix.

FIG. 14 shows a plurality of biovoxels in the shape of boxes of different sizes for accommodating plants of different sizes or at different stages of development.

FIGS. 15-15B and 16 show various embodiments of biovoxels as a matrix of boxes and/or drawers in a growth capsule.

FIGS. 17-18 show embodiments of a large capsule which may be referred to as a growth capsule that includes smaller individual cells.

FIG. 19 shows a set of biovoxels as stacked cubes.

FIG. 20 shows a block diagram of a system according to an embodiment of the invention for operating a growth vessel.

FIG. 21 shows a method according to the invention for providing actuator signals to a capsule.

FIGS. 22A-22G show exemplary capsule representations having a modular configuration to accommodate multiple plants at a wide range of scales.

FIGS. 23A-23F illustrate exemplary capsule configurations with different wall, ceiling, and floor structure options.

FIGS. 24A-24D illustrate additional exemplary capsule representations having different wall structure configurations.

FIGS. 25A-25F are top perspective views of illustrative capsule embodiments.

FIGS. 26A-26F show details of exemplary biovoxels for growing plants in different environments of a capsule.

FIGS. 27A-27D show biovoxels forming relationships with neighboring biovoxels to gain social intelligence

FIG. 28 shows a matrix of biovoxels in a wall-mounted frame of a capsule.

FIG. 29 shows manipulation of biovoxels using a robotic arm.

FIGS. 29A-29D illustrate exemplary embodiments of different kinds of biovoxels for use in growing plants.

FIG. 30 shows an exemplary set of biovoxel components that can be mixed and matched into assemblies depending on the needs of a particular experiment.

FIG. 31 shows an exemplary assembly of a biovoxel and its component parts.

FIGS. 32A and 32B show connectors for attachment of a biovoxel to a support matrix or capsule wall according to an exemplary embodiment.

FIG. 33 shows exemplary embodiments of biovoxels having universal connectors for attachment to a capsule.

FIG. 34 illustrates a set of wall-mounted biovoxels which are interconnected for exchange of gases, water, volatile compounds, and other substances between individual biovoxels.

FIGS. 35A and 35B show exemplary embodiments of intrastructure connections for biovoxels to a capsule or capsule wall.

### DETAILED DESCRIPTION OF THE PRESENT SYSTEM

The present invention relates generally to control and regulation of the growth of biological material or organisms, such as plants, combining environmental templating with genetic augmentation for purposes of design and construction of bio-augmented or bio-consumable products, structures, tangible goods and building materials, including engineered hybrid plant products.

The invention provides specific fine control of environmental input. Moreover, a growth capsule facilitates reproducibility, which means that by allowing fine-tuned control over any combination of variables such as environmental inputs (e.g., light, humidity, soil nutrient composition). Growth capsules facilitate this critical attribute of scientific research allowing for the ability to consistently produce an identical product. Instead of a conventional growth environment, the capsule is used as an isolated growth vessel and/or included in a larger growth chamber and used for growing products, such as plants, scientific model organisms and bioconsumable products. Such capsules allow for the design and potential fabrication of products such as hybrid plant products, hybrid living materials, building materials, textile materials and the like.

In the following description, for purposes of explanation rather than limitation, illustrative details are set forth such as architecture, interfaces, techniques, element attributes, etc. However, it will be apparent to those having ordinary skill in the art that other embodiments that depart from these details would be understood to be within the scope of the appended claims. Moreover, for purposes of clarity, detailed descriptions of well-known devices, circuits, tools, techniques, and methods are omitted so as not to obscure the description of the present invention. The term “and/or” and formatives thereof should be understood to mean that only one or more the recited elements may need to be suitably present in an embodiment in accordance with the claimed recitation. In addition, dimensions provided are exemplary and may be rounded for convenience and provided in multiple units to facilitate understanding. The present growth system can be used to manufacture hybrid plant products with or without a template, as well as growing conventional plants for research purposes or commercially.

Hybrid Plant Product

One aspect of the invention involves a system for growing a plant such as a new hybrid plant product (HPP), in certain embodiments using a hybrid plant product template.

A hybrid plant product includes any plant- or other microorganism-based consumable product, component or materials which has been fully or partially grown in a laboratory or other highly controlled environment. For example, HPPs may include a garment, tangible good, building material, structural material, textile, a shoe or any other article manufactured using live bioorganism materials. In certain embodiments, a propagative plant structure (PPS), a plant tissue that can be cultivated to grow a plant, such as a seed, spore, shoot, cutting, plant stem cell(s), precursor cells, or fruit may be grown in a specialized controlled-environment growth capsule of the present invention.

Hybrid Plant Product Template

In certain embodiments, it may be desirable to use a hybrid plant product template (HPPT) to cause a plant to grow in a particular manner to obtain a HPP. A HPPT may be a 3D material volume, such as comprising seeds, soil and their combination; bio-based materials, such as hydrogel or other growth media; and/or polymers, that have been manufactured (e.g., 3D printed) to reflect a spatial pattern for growth augmentation and control, thus forming a “programmable soil” providing a nutritional growth medium for regulated and templated growth.

An HPPT may, for example, include one or more the following: (a) a solid yet porous polymer structure; (b) diffusible chemicals embedded into the solid polymer structure; (c) a PPS; (d) hydrogel; and (e) a colloid. The hydrogel may comprise a thin aqueous gel coating that conforms to and is infused within the polymer structure surrounding the propagative plant structure. The polymer solid structure and hydrogel structure may contain nutrients and growth media for germinating seeds including, for example, peat moss, vermiculite, or perlite. The polymer solid and hydrogel structures may provide transport for diffusible colloids and a hospitable environment in which a PPS can grow. In certain embodiments, a photopolymer may be desirable because deposition of commonly used biocompatible photopolymers is already achievable in 3D at submicron resolution and also because a variety of mechanical and optical properties of these materials can be varied by the amount of photopolymerization.

The precise material composition and distribution of the HPPT, including nutrients, diffusible chemicals and other additives may be computationally designed across the 3D volume and even controlled over time by, for example, injecting additional materials, inducing changes such as by chemical, mechanical, electrical or thermodynamic methods, or programming decomposition or other behaviors into the initial material. Nutrients, such as oxygen, carbon dioxide, calcium, phosphorus, potassium and/or nitrogen; diffusible chemicals, such as chemical signaling liquids, photopolymers, and pigments; and other additives, such as metals, may be similarly deposited strategically across the 3D volume of the HPPT. At least one PPS may be deposited anywhere inside or on the surface of the HPPT. As it grows, a PPS, especially the root system of a PPS, will be influenced by the HPPT material composition and distribution.

The HPPT may regulate gene expression of the plant in such a way as to control the production of proteins, RNA or enzymatic reactions in different spatial regions of the structure surface, in relation to diffusible chemical concentrations. For example, certain genes may be expressed when the growing root encounters a chemical signaling liquid; or a plant may begin to synthesize gold nanoparticles when it encounters and uptakes chloroaurate solution suspended in the hydrogel. The HPPT thus enables high-resolution design of individual plants and growth media.

For ease of discussion, a plant (or HPP) will be treated as growing in “soil”. The term “soil” as used herein is any micronutrient rich substrate, such as media with variable content of key macronutrients such as nitrogen (N), phosphorus (P), potassium (K), calcium (Ca), sulfur (S), magnesium (Mg), carbon (C), oxygen (O), hydrogen (H), as well as modifiable water content, mechanical properties (porosity, stiffness, optical transparency). As such, it is understood that plants or HPPs may be grown in other environments, such as, e.g., hydroponically or in a hydrogel.

Methods of Making a Hybrid Plant Product Template

The HPPT or components of the HPPT may be manufactured by configuring a 3D printer, such as a standard multimaterial 3D printer. Preferably, biovoxel-based 3D printing (also referred to as bitmap 3D printing) methods are applied to the manufacturing workflow to enable more precise deposition of discontinuous data types. Additional aspects of preparing HPPTs and the resulting HPPTs are discussed in applicant's co-pending PCT patent application entitled “Methods and Apparatus For High-Resolution Textile Fabrication With Multimaterial Intelligent Fibers”, filed on even date herewith and incorporated herein by reference in its entirety.

A commercial 3D printer may, in accordance with digital instructions, precisely control the amount and type of materials that are deposited to form different spatial regions of the HPPT. For instance, the 3D printer may include a processor configured to control where and in what concentration each nutrient and/or chemical signal is deposited. Based on instructions stored in a memory operationally coupled to the processor, the processor may control the 3D printer to deposit the nutrients and/or chemicals (also referred to as chemical signals) in continuous (and/or discrete, step-wise) gradients in such a way that each chemical signal has a different distribution of concentrations throughout the structure. The 3D printer in combination with the processor and memory, collectively referred to as the 3D printer, may control the material properties (e.g., absorbency, diffusivity, hardness, rigidity, tensile strength, compressive strength, transparency, color) of the HPPT such that they vary as a function of spatial position in the structure. For example, the 3D printer may deposit materials in such a way as to cause: (a) some regions of the HPPT to be hard and rigid and other regions to be soft and flexible; and (b) some regions of the HPPT to have a higher diffusivity and thus facilitating more rapid diffusion of embedded chemical signals than other regions.

Hydrogel 3D printing facilitates cooperation with nature to not only build and assemble but also grow structures with entirely new forms, functions, and life cycles. An exemplary method of making an HPPT uses a hydrogel 3D printer, which is capable of nontoxic additive manufacturing with 100% biodegradable matter at scale. Hydrogel 3D printing has increasingly been leveraged in biomedical applications such as tissue engineering, surgical training, and wearable electronics. Beyond the creation of predetermined synthetic structures, it enables the spatial templating of organic growth in multiple domains.

In one implementation, a three-axis gantry comprises position sensors and stepper motors for travel along x, y, and z. A pneumatically actuated end effector serves as both reservoir and extruder for a “bio-ink” which is a hydrogel infused with pigments, such as insoluble bone black (PBk9™) in a linseed oil vehicle. Travel speed and extrusion rate can be varied along user-defined toolpaths in 2.5 dimensions. The bio-ink extrudes directly into a clear hydrogel substrate, such as Water-Sorb Hydro PAM (Polyacrylamide), which is often used as a soil alternative.

In printing, the substrate volume was defined by an acrylic tray measuring up to 128 in³/2 L(8 in×8 in×2 in, or 20 cm×20 cm×2.5 cm). However, the nature of liquid 3D printing eliminates structural and gravitational constraints inherent to other forms of additive manufacturing with rigid materials, opening the possibility of printing large-scale objects with high resolution. Extruded bio-ink is suspended in 3D space; the bio-ink is not limited to the sliced layer-by-layer deposition constraints of conventional 3D printing methods and instead newly deposited material is free to interact with previously extruded material, for example, by diffusion. With the addition of a curing (e.g., UV light), crosslinking, or dissolving mechanism, the bio-ink object may be extracted completely from the hydrogel matrix.

Furthermore, the use of hydrogels unlocks a rich material palette. Natural pigments, including anthocyanins, flavonoids, and carotenoids, become available, as do other materials with bio-cultural relevance. By parametrically varying the components and material properties of the hydrogel substrate and bio-ink, the precise form and function of the printed object can be tuned. Glycerin, propylene glycol, spirulina powder, food coloring, and agar have been explored in varying concentrations. In one embodiment nutrients may be printed along intentional paths to template the growth of organisms, from plants to bacteria, over time and space.

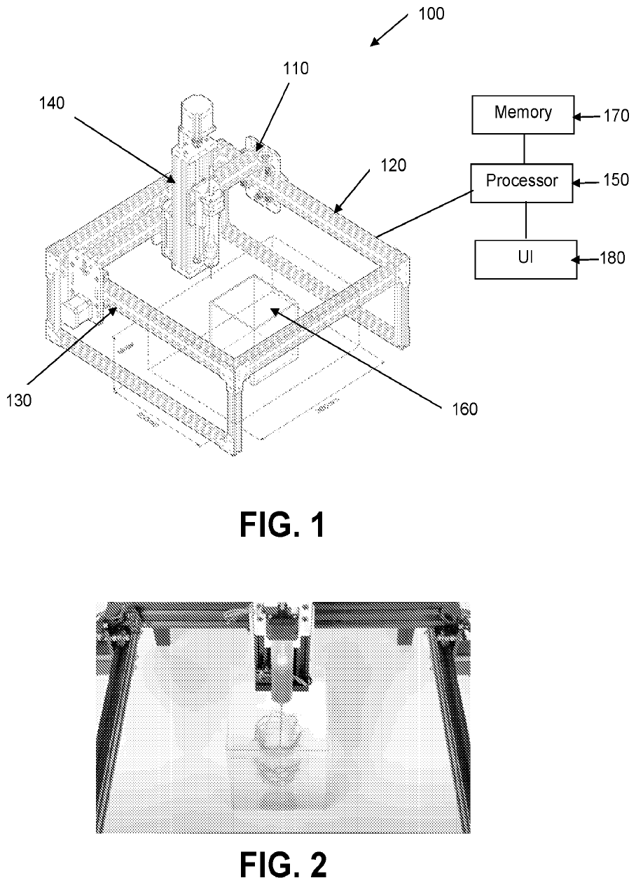

FIG. 1 shows a 3D printer setup showing printer 100 having a movable arm 110 that slides along tracks 120, 130 in first direction. An injector 140 is movably attached to the movable arm 110 and is movable in a second direction which is orthogonal to the first direction. The movable arm 110 and injector 140 are moved as actuated by stepper motors in x, y, and z directions, under the control of a processor 150 which also controls the flow of material from the pneumatically actuated injector 140 into a hydrogel cube 160. FIG. 1 also shows a memory 170 operationally coupled to the processor 150 and includes instructions when executed by the processor 150, cause the processor 150 to perform operational acts such as moving the injector to a desired position and causing the release and injection of desired material. Further a user interface (UI) 180 is also operationally coupled to the processor 150 to allow user input, such as a keyboard, mouse, touch screen and the like. A display may also be operationally coupled to the processor 150 to output and provide output images and/or video of the 3D printed products and/or the growing biological matter.

FIG. 2 shows the 3D printer 100 printing black pigment (e.g., insoluble bone black (PBk9™) in a linseed oil vehicle) into the hydrogel (e.g., Water-Sorb Hydro PAM (Polyacrylamide), which may be used as a soil alternative) injected by the injector 140, resulting in a completely biodegradable, nontoxic hydrogel infused with black pigment at precisely designed points in a 3D volume. The black pigment serves as a demonstration of a biocompatible material embedded into a biocompatible hydrogel relevant for plant growth, thereby demonstrating the feasibility such combinations with other biocompatible materials and hydrogels.

For example a HPP may be placed upon the surface of a bio-ink network impregnated with nutrients. The developing root system will follow the printed nutrients path through the water-based hydrogel substrate, growing into a design-mediated form. The black pigment illustrates exemplary patterns of distribution within the HPPT attainable using the present invention. As shown in FIGS. 2-9, any desired pattern may be printed at high-resolution using the 3D printer 100, and is not limited to the sliced layer-by-layer deposition constraints of conventional 3D printing methods.

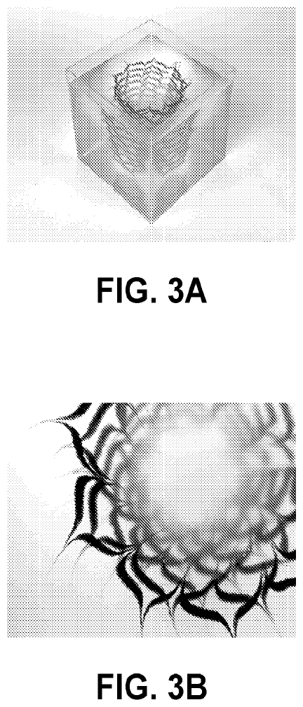

FIG. 3A shows a hydrogel infused with a first pattern of black pigment, where FIG. 3B shows the first pattern of black pigment in greater detail.

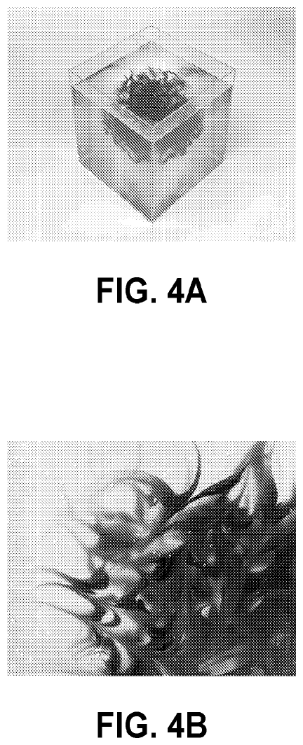

FIG. 4A shows a hydrogel infused with a second pattern of black pigment, where FIG. 4B shows the second pattern of black pigment in greater detail. Any other desired pattern may be printed by the 3D printer 100 under the control of the processor 150.

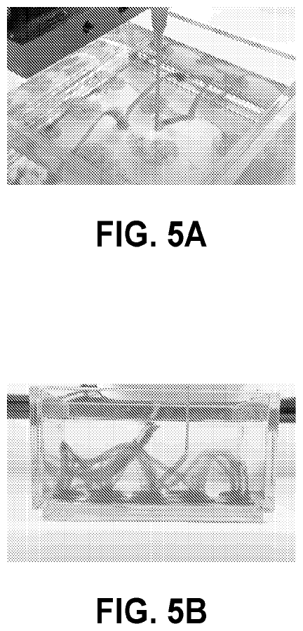

FIGS. 5A and 5B show top and side views, respectively, of a propylene glycol carrying spirulina as a pigment, deposited by the injector 140 in a zig zag pattern in a volume of propylene glycol.

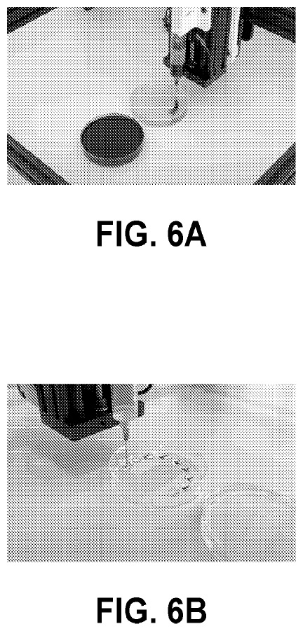

FIG. 6A shows extruding agar with food coloring from the injector 140 into agar. Further, FIG. 6B shows extruding water into hydrogel deposited from the injector 140.

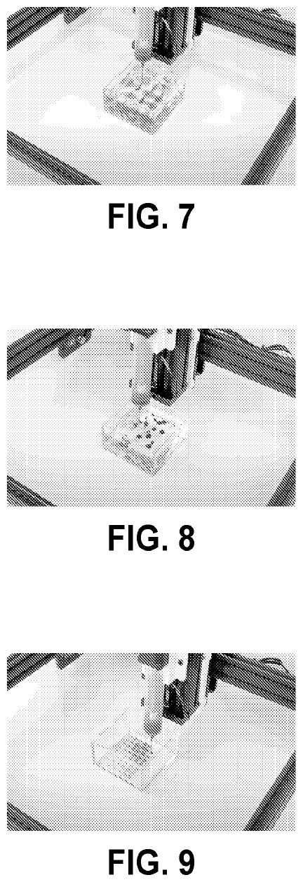

FIGS. 7 and 8 show extruding propylene glycol carrying dissolved food coloring pigment, deposited from the injector 140 in a zig zag pattern in propylene glycol.

FIG. 9 shows extruding dyed glycerin from the injector 140 printed without a substrate with calibrated negative pressure.

HPPT Examples

In an illustrative example, a seed is placed upon the surface of a bio-ink network impregnated with nutrients. The developing root system will follow the printed nutrients path through the water-based hydrogel substrate, growing into a design-mediated form. During the printing process, a delivery device or injector, such as a syringe, may be programmed to inject oxygenated air bubbles, fueling or influencing the roots in yet other ways. Strategic infusion of growth inhibitors across the HPPT might define an invisible bounding box within which the roots take form. As biological matter is environmentally responsive, the grown form may be continually influenced by environmental parameters, such as light or the introduction of new materials into the matrix.

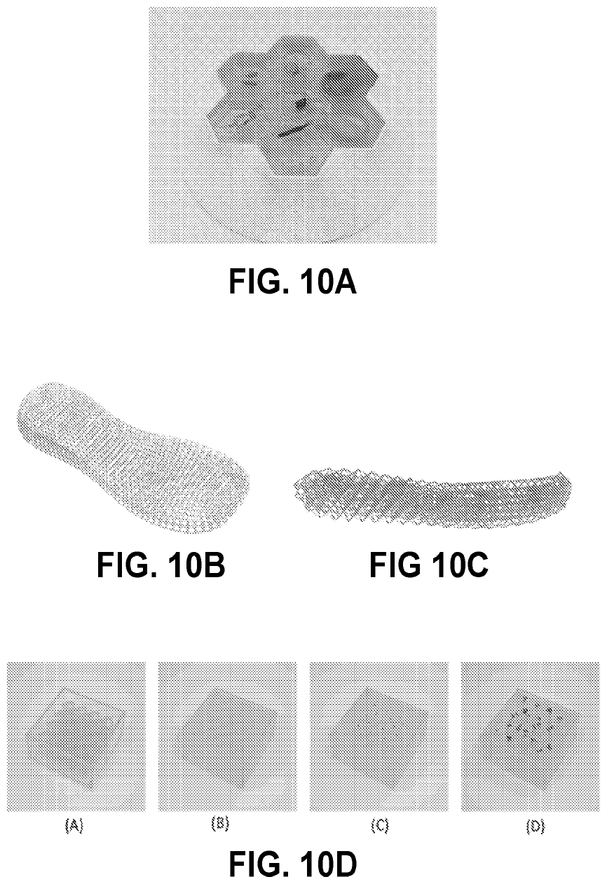

FIGS. 10A, 10B and 10C show an example in which a semi-rigid scaffold for a shoe sole is 3D printed in a multicellular geometry. It is placed in a container which forms a bounding box for the shoe sole and which is then filled with hydrogel-based growth media, together comprising the HPPT. This same HPPT may be bitmap printed using the multimaterial hydrogel 3D printer. As shown in FIG. 10D, cotton seeds are injected into the HPPT at the center of every cell defined by the scaffold. As the growing cotton plant emerges from the HPPT, it may continue to be directed to grow into the shoe upper through a combination of HPPT parameters, environmental growth conditions, and interaction with technologies such as 3D printers, looms, electrospinning machines, clinostats, robotic arms, and human interaction.

Capsules

One aspect of the present invention is directed to an improved environmental growth capsule which contains one or more growth vessels (termed “biovoxels”) for the purpose of controlled variation of environmental parameters. A capsule is an improved or enhanced environmental growth capsule which may have an “intelligent skin” infrastructure to provide structural support, the provisioning of nutrients, and the ability to monitor and control the environmental conditions for the purpose of producing bio-augmented or bio-consumable products, including HPPs.

The “intelligent skin” (detailed below) may be one or more of the walls, floor and ceiling of a capsule and/or an individual “biovoxel” growth vessel. Each biovoxel may be independently and individually controlled by a processor to regulate various aspects of the biovoxel, such as the intelligent skin, to tune various environmental factors of the capsule, such as pH, temperature, humidity, light, nutrients, water, drainage and/or air flow, monitored by sensors configured to detect, observe, monitor, sense and record such parameters and their resultant phenotypes, for example, and provide the sensed information to the processor for control of such parameters. Such a biovoxel may also be considered as a bioreactor that supports a biologically active environment. For example, a biovoxel may be a vessel in which a chemical process is carried out which involves organisms, such as plants, algae, bacteria and the like, and/or biochemically active substances derived from such organisms.

As previously discussed, the capsules of the invention may be carried out using artificial intelligence. In this manner, the system learns to adjust growing conditions and parameters for various plants or other growing organisms. Exemplary vendors of artificial intelligence software programming modules include Google, Intel, NVidia, and others. Artificial intelligence can be hosted on a computer system connected to the invention, or the artificial intelligence can be cloud-based as is known in the art.

Capsule Macrostructure

The capsule macrostructure is a room that is suitable for integration into architectural spaces. This allows an operational workflow that can span office space, wet lab space, machining facilities, prototyping facilities, 3D printing facilities, decontamination rooms, data centers, commercial space, public exhibitions, show rooms, etc. For example, the capsule macrostructure may be a way to conduct scientific experiments and/or a way to display products that can be manufactured or displayed therein.

In one embodiment, for example, the capsule has six walls, including the floor and the ceiling. One wall may, for example, be entirely comprised of glass which is acoustically and thermally insulating and optically transparent to allow for observation of internal elements. Optionally, the transparent, e.g., glass, wall accommodates blackout shades, electro-chromatic opacity control, light filtering, interactivity (e.g., touchscreen user interface, data displays), and/or a door through which a user may enter/exit adjacent spaces. The back wall may include a door that allows a user to enter/exit through a clean room or corridor. This clean space minimizes the transfer of biological agents and other contaminants between the capsule and adjacent spaces as materials such as equipment and soil are transported in and out. Materials may be sterilized by methods such as autoclaving, ultraviolet light, chemicals, or washing. The capsule itself may have a biosafety level 2 (BL2) designation or other biocontainment protocol in place to enable the use of biohazardous agents, including microorganisms, and may accommodate additional mobile or integrated biosafety cabinets.

In one embodiment, at least one or all non-glass walls may comprise at least one of an intelligent skin, a highly perforated mechanical shell, an “arterial space” (e.g., multifunctional or mechanical zones behind the shell), an electronic control system, a user interface for systems control, finish panels/surfaces, equipment, fixtures, and services that penetrate or are mounted to the shell. The shell may comprise a grid system of railings or tracks onto which components such as sensors, scanners, diffusers, shelving, lighting, growth aids, and temporary devices for delivery of any services may be securely mounted. This modular infrastructure enables maximum flexibility in equipment and spatial use. Some or all the walls may be configured to comprise a plant that may be grown horizontally from the vertical walls, on freestanding shelves placed in the center of the room, or upside down from the ceiling, for example.

Environmental services and communication systems may be transported to the intelligent skin and perforated shell from external reservoirs or climate conditioning units via a network of plumbing, wiring, and electronics in the arterial space. In one example, an initial climate conditioning unit outputs air of a specific temperature, humidity, and gas composition into the uniform arterial space; airflow into the capsule interior may be regulated via mechanisms in the arterial space (e.g., valves controlled by an electronic control system or a differential fan array) or via the intelligent skin.

Intelligent Skin

The intelligent skin infrastructure on the walls of the capsule provides critical functions to support, monitor, control and extract outputs regarding the environmental conditions of the individual biovoxels operationally connected thereto. These functions may include at least one of: (a) a system of structural support; (b) provisioning of various nutrients such as oxygen, carbon dioxide, phosphorus, potassium and/or nitrogen as well as other nutrients as needed; (c) an irrigation system; (d) an airflow and humidity system; (e) temperature control; and (f) control of light. The intelligent skin infrastructure, which is adjacent to each biovoxel may be porous in order to facilitate such provisioning of nutrients and delivery of related environmental elements. The intelligent skin infrastructure may also contain interfaces for provisioning of services such as water, air, or electrical power for adjusting an individual biovoxel microenvironment as appropriate. The intelligent skin infrastructure advantageously allows for the highly tunable differentiation of microenvironmental conditions across a 3D garden of bio-augmented products, facilitating an extremely high number of controllable spatiotemporal growing scenarios. The intelligent skin may comprise environmental pixels, which are 2D sections of the intelligent skin and the smallest two-dimensional unit that can read and write information to support a controlled microclimate.

The intelligent skin infrastructure may comprise sensors such as for pH, temperature, humidity, air (oxygen, and/or carbon dioxide), and nutrients (phosphorus, potassium, nitrogen and/or other nutrients), and/or multifunction sensor that take readings from various sources such as the nutrient medium, HPPT or the air within or adjacent to specific biovoxels or environmental pixels. The intelligent skin may also comprise a microcontroller, or a central industrial computer or processor configured to collect period or real-time data and to differentially control and adjust the environmental conditions for specific aspects of the biovoxels.

The constellation of environmental sensors, microcontroller, and industrial computer may be placed internal to, adjacent, and/or near the wall(s) of an associated or nearby biovoxel or group of biovoxels. The intelligent skin may also include a camera, for example a digital phenotyping camera, that is pointed at some location on or near the biovoxel(s) and provides readings, which may be used in conjunction with a computer vision system deploying deep learning algorithms to control and adjust the environmental inputs of those biovoxels, in some aspects via artificial intelligence.

In one embodiment, the intelligent skin may, for example, be the innermost layer of the capsule walls. The intelligent skin, for example: (1) facilitates parallelized or multiplexed control of environmental and nutritional conditions, and (2) supports communication between growing plants and their environments. These functions may occur at the resolution of a 2D environmental pixel or a 3D biovoxel. A biovoxel may be any shape, such as, e.g., spherical or bubble, cylindrical, cube or cuboid, etc. The intelligent skin may be a three-dimensional matrix of, for example tens to millions of, biovoxels or environmental pixels.

To facilitate control of environmental and nutritional conditions, the intelligent skin serves as a regulatory membrane across which climate conditioned air, water, nutrients, soil, and other environmental services may be bi-directionally exchanged between the arterial space and the capsule interior. Each biovoxel or environmental pixel is a function of its input/output services and can be turned “on” to allow transmission across the intelligent skin, “off” to block transmission, or partially “on” to filter transmission. Information may be written to it by a processor, resulting in tuning of an environmental condition, or read from it, resulting in collection of sensor data in a computer or cloud database. Together, the microclimates of each biovoxel may, in one embodiment, comprise a macroclimate within the capsule macrostructure. Depending on the distribution, scale and programmed services of the biovoxels, the macroclimate may be homogeneous across its volume or may vary along a three-dimensional gradient or be randomly assigned.

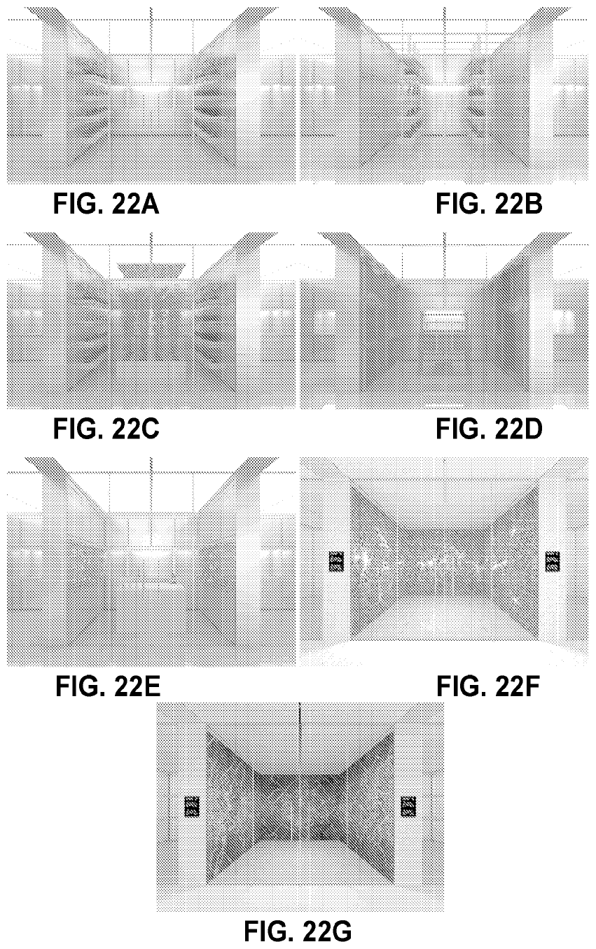

To support communication between growing plants and their environments, an intelligent skin may be digitally configured as a three-dimensional cellular automaton, such that a biovoxel can turn “on” or “off” according to a computational rule set based on the states of its neighboring biovoxels. A representation of this communication network is shown in FIGS. 22F-22G. Interaction between biovoxels can occur via electricity, magnetism, vibration, or other physically useful means within the intelligent skin itself, and it can also occur by expression of phenotypes in the organisms, sensed and responded to by the intelligent skin or directly by neighboring organisms. Given that the state of each biovoxel has a direct effect on the state of at least one growing organism in the capsule, this results in the formation of complex, cascading patterns of growth and gene expression. This is interesting not only as a mechanism for social intelligence across organisms but also as a potential new domain for intensive computational information processing.

For any growing organism it surrounds, the intelligent skin may be programmed to control at least one environmental parameter, such as temperature, humidity, light, water, drainage, pressure, and/or air flow; at least one nutritional parameter, such as oxygen, carbon dioxide, calcium, phosphorus, potassium, nitrogen, diffusible chemical, and/or additives; at least one sensor, such as a standard camera, digital phenotyping camera, motion detector, temperature sensor, humidity sensor, light sensor, color sensor, pH sensor, and/or optical fiber; and/or at least one actuator, a device which carries out a particular function and responds to signals received from a sensor in a growing environment, for example, a fan (circulating air), blower (inputting air), pump or valve (opening or closing to input or discontinue inputting water, nutrient fluid, or other substance), and/or robot (manipulation of a growth environment). It may be networked to communicate with one or more digital instruments, such as a computer, microcontroller, processor, memory device, storage device, Bluetooth chip, WiFi chip, and/or power supply.

Biovoxels

Unlike traditional grow rooms where plants share common environments, biovoxels are controlled environments for single organisms. Individual biovoxels may, for example, be 1000-2000 mL in volume, and each biovoxel in a capsule can be individually adjusted for environmental parameters such as humidity, temperature, atmosphere, and lighting, in conjunction with gas and fluid inputs like a miniature grow room. Other sizes for the biovoxel are within the scope of the invention as will be clear to the skilled person. Organisms inside a biovoxel can be observed with a camera and analyzed with a variety of sensors. Each biovoxel within a capsule is designed to run fully automated protocols to allow the biovoxel to be continuously maintained in an unattended manner over the course of any number of days.

Each biovoxel, as well as the ancillary technical or structural equipment such as (but not limited to) a robotic arm or gantry is connected to a local area network to log data for real-time analytics which is then fed back into adjustments to refine the environment inside each biovoxel via a feedback loop. The system can optionally be adjusted using electronic means such as artificial intelligence, or the system may be programmed by a user to conduct experiments in a particular manner or to provide growth recommendations.

Biovoxels are especially suited for growing the hybrid plant products discussed above, in certain embodiments using hybrid plant product templates.

Temperature

Capsules are generally designed to offer temperature control spanning a comfortable range under natural conditions for plants. Generally, the active range is from ambient room temperature (˜20° C.) to ˜30° C. Extended temperature ranges (10° C. to 60° C.) may be preferred for cold cycles or hot cycles used for basic sterilization or decontamination protocols.

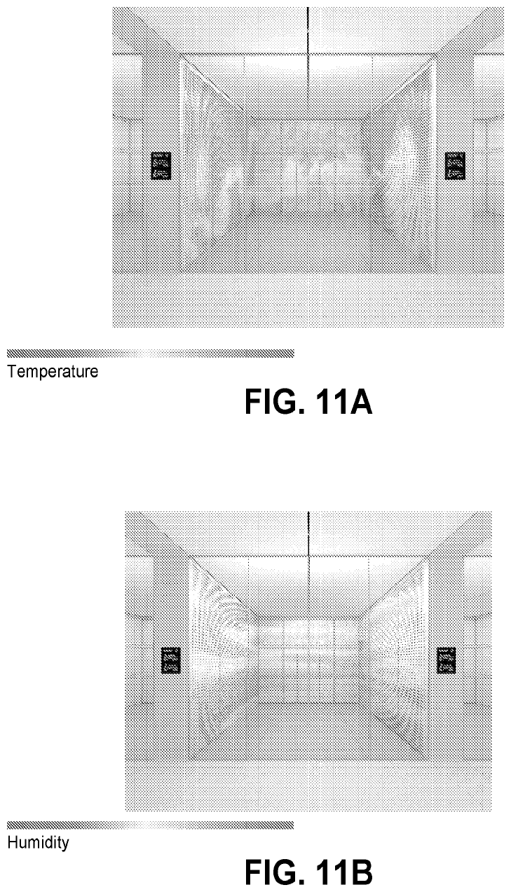

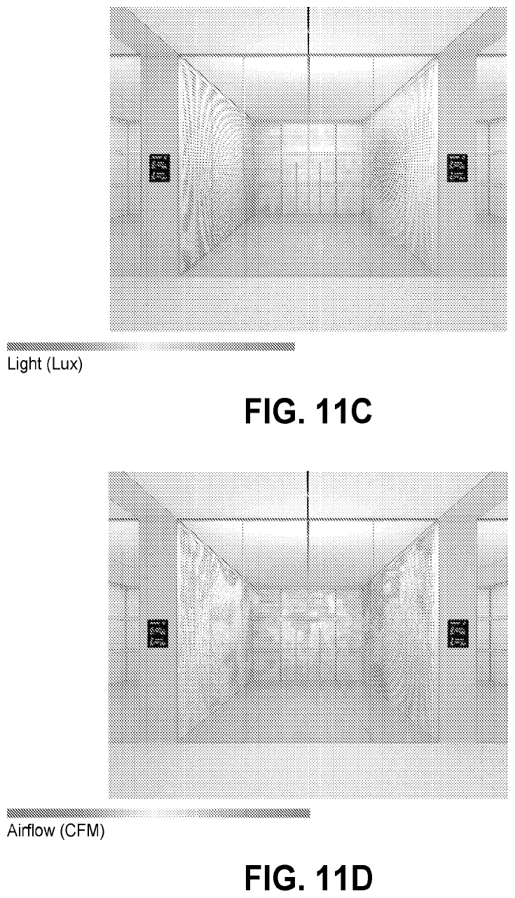

FIG. 11A shows a capsule according to one embodiment having walls where various portions of the wall(s) are independently temperature controlled. It should be understood that the capsule shown in FIG. 11A may be a large capsule accommodating a large plurality of objects such as plants to be grown, or the capsule may be a small capsule accommodating a small number of biovoxels. If the contained plant is very large, a capsule may contain only a single biovoxel. The space in which the capsule is located itself may or may not have environmental control.

Temperature control of the individual biovoxels may be provided by independent heating and cooling elements controlled by a processor. The heating and cooling elements may be any known or future developed elements, such as Peltier elements, resistive elements, cooling tubes for flow of cooling fluids and the like located within or adjacent to walls or intelligent skin of each environmental pixel. Such heating and cooling elements are associated with individual environmental pixels for independent temperature control of each environmental pixel.

Humidity

As plants transpire, the surrounding humidity saturates leaves with water vapor. When relative humidity levels are too high or there is a lack of air circulation, a plant cannot make water evaporate (part of the transpiration process) or draw nutrients from the soil. Humidity can be either added or removed by the processes of humidification or dehumidification. Several modes of humidity control are provided, such as pan-type or reservoir humidifiers, ultrasonic humidifiers, forced-air spray nozzles or mist, and refrigeration/cooling coil dehumidifiers. Each environmental pixel and/or biovoxel may have ports and channels connected between the environmental pixel/biovoxel ports and central humidification or dehumidification devices via individually controlled valves (that open and close to change humidity, as well as other environmental parameters such as airflow and temperature, for example) to individually and independently control the humidity of each biovoxel. FIG. 11B shows a capsule according to one embodiment having walls where various portions of the wall(s) are independently humidity controlled.

Light

The walls or intelligent skin of each environmental pixel or biovoxel may include light panels or light environmental pixels, such as LED panels with either white or tunable full-spectrum light, high-intensity discharge lights, fluorescent lights, ultraviolet, germicidal, and/or aquatic lighting. As with temperature and humidity control, the light provided to each environmental pixel or biovoxel is individually and independently controlled by the processor to provide light of a desired wavelength and/or intensity in response to sensor signals from the various sensors of each environmental pixel or biovoxel, namely, temperature, humidity, light and air flow sensors, for example. FIG. 11C shows a capsule according to one embodiment having walls where various portions of the wall(s) are independently light controlled.

Airflow

Ideal plant growing conditions requires specific airflows at different stages of the plant's life cycle. Accordingly, the processor regulates airflow of each environmental pixel or biovoxel individually and independently by pushing air uniformly through perforations in wall(s) of each environmental pixel or biovoxel. As is well-known, vents, channels and valves may be used in conjunction with the perforations to control airflow and/or other fluids and connect individual environmental pixels or biovoxels to a central air flow device, such as a fan, blower, pump and the like. FIG. 11D shows a capsule according to one embodiment having walls where various portions of the wall(s) are independently airflow controlled.

Each capsule may be subdivided into one or more distinct growing areas which facilitate additional containment, experimentation, communication, programming, growth, and display of organisms. Each such subdivision may be considered to be a smaller, modular capsule which may be independently and individually controlled by a processor to regulate various aspects, such as the intelligent skin, to tune various environmental factors of the microclimate within the capsule, and may contain one or more biovoxels or individual organisms that share some subset of growth and communication conditions such as soil, air (for aeroponic growth), water (for hydroponic growth), and HPPTs, enabling hierarchical control of conditions at local, regional and global levels within the capsule.

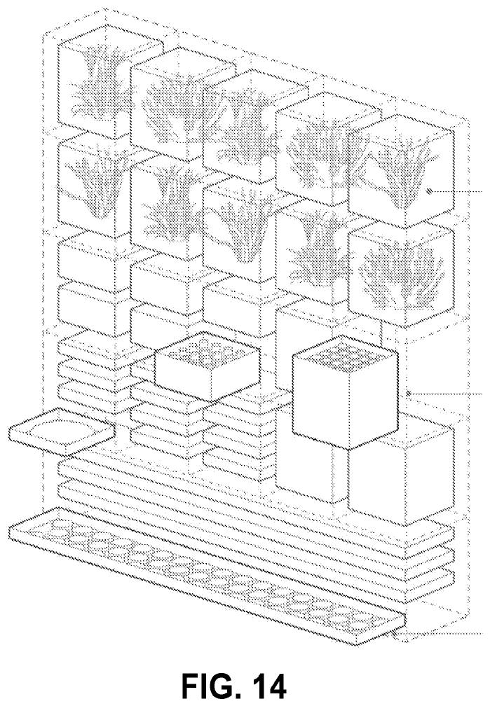

Capsules may also be smaller than room sized. Such smaller capsules may be arranged in various configurations (as shown in FIGS. 14-19), such as affixed to vertical wall faces (as in vertical farming), mounted on wall shelving, hung from the ceiling, or placed on the floor. Configurations and size of the capsules may be driven by expected physical properties of the plants throughout their lifecycles—e.g., height (for example, bamboo vs. cotton).

Design of each biovoxel is highly customizable and may be informed by experimental parameters. For example, if light is a global variable within the capsule, the biovoxels may be transparent; if temperature and humidity are regional variables, then a set of biovoxels may be permeable to air and further contained by an impermeable larger structure. Each port (as further discussed herein) may be directly connected to the intelligent skin, allowing local exchange of climate conditioned airflow, water, nutrients, and other services between the arterial space and the biovoxel or capsule interior. Each port may alternatively be connected to local service modules and communication systems mounted inside the capsule, e.g., filtered gas lines, irrigation lines, fiber optics, temperature sensors, and pH sensors. Ports may also be used to open physical channels between two or more biovoxels. A set of multiple ports may be located on a single easily interchangeable surface, such as the lid or cover of the biovoxel. This modularity lowers the number of unique features of each component, which results in lower cost, inventory, material, and time.

The capsules and biovoxels may be equipped with various sensors, for example, cameras, digital phenotyping cameras, temperature sensors, pH sensors, etc., to detect, observe, monitor, and record environmental conditions, phenotype expression, and other growth patterns. Sensors may be integrated into the intelligent skin, mounted on the grid infrastructure, or plugged into the ports of the biovoxels. Data collected from the sensors may be read by the intelligent skin and used to provide real-time control, including for purposes of machine learning. Together with the biovoxels, the sensors provide a feedback loop needed for growing products, structures, tangible goods, and building materials at scale, in accordance with the principles of the present invention.

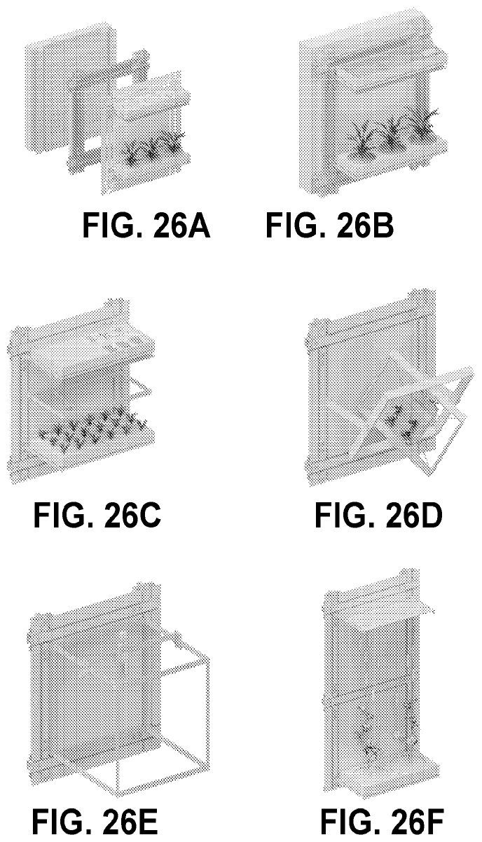

In addition to the services and sensors described here, a biovoxel may also interface with such equipment as clinostats, 3D printers, and looms (FIGS. 26A-26F). There may also be a user interface to allow humans to adjust the parameters of the invention.

A listing of features and instrumentation for use in a capsule or biovoxel includes the following exemplary components, which may be used in any suitable combination:
Microcontrollers and embedded computers;
Imaging equipment, including standard photography, infrared, digital phenotyping cameras, motion detectors;
Sensors, such as for monitoring or detecting pH, dissolved oxygen, toxicity, temperature, humidity, color, atmospheric pressure, and gas analyzers;
Actuators, such as fans for fine-grain air tempering; peristaltic pumps for moving precise volumes of fluids; stepper motors, servo motors, and pneumatic actuators;
Power supplies, structural supports, and conveying equipment such as ceiling hanging or rigging points;
Plumbing, such as domestic water piping, sanitary sewage piping, compressed air systems, vacuum systems, gas (carbon dioxide, oxygen, nitrogen) systems, chemical waste systems, and processed water systems (e.g., reverse osmosis);
Heating, ventilation, and air conditioning (HVAC), cooling, hydronic distribution, and exhaust air;
Fire protection: water-based or non-water based, including sprinklers;
Electrical equipment, such as packaged generator assemblies, transfer switches, electrical supply, power distribution, facility grounding, lighting control, and branch wiring;
Communications, such as data, voice, and audiovisual equipment;
Safety and security devices, such as equipment for access control and intrusion detection, electronic surveillance, detection and alarm, and electronic monitoring and control, including integrated automation services; and
Education and scientific equipment, such as a biological safety cabinet, incubator (tri-gas or conventional), infrared heat lamp, refrigerator, sinks, cabinets, countertops, shelving, and moveable structural elements.

Environmental Pixel Examples

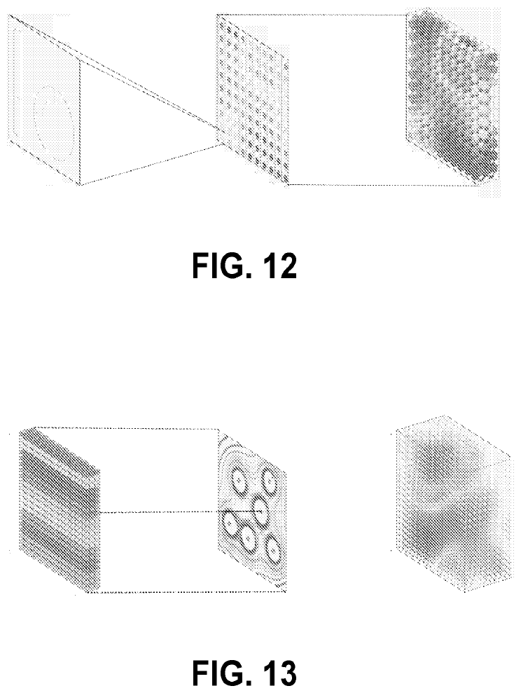

FIG. 12 shows one environmental pixel that is representative of a portion of an intelligent skin of a capsule or a biovoxel surrounding a growing organism such as a plant. A plurality of individually addressable environmental pixels may form an array within the intelligent skin(s). The array may be of any shape and size, such as a square of square environmental pixels of 100 mm by 100 mm, for example. These environmental pixels may each be networked to communicate with a computer, micro-controller and/or processor which is operatively coupled to the intelligent skin. The processor may be configured to individually and independently control various parameters for each environmental pixel, such as temperature (e.g., from 20° C. to 60° C.), humidity (e.g., from 0-100%) and light (e.g., of any desired wavelength). In addition, each environmental pixel of the intelligent skin may include a growth substrate or a reservoir for storage and release of nutrients, provided to the plant surrounded by the intelligent skin and under the control of the processor.

Alternately or in addition, the capsule wall may include a plurality of PPS or seeds arranged in a matrix, referred to as a seed bank, as shown in FIG. 13. Each seed in the matrix may be any desired seed, such as a targeted biodiversity species, which may be the same or different from an adjacent seed in the matrix, such as a first set storing species A, a second set storing species B, and a third set storing species C, for example. Each seed may be stored in a unit such as a storage bin, an environmentally templated material, or a growth substrate. The x,y-position of each seed may correspond to, for example, the x,y-position of one environmental pixels. These environmental pixels may each be networked to communicate with a computer, microcontroller and/or processor which is operatively coupled to the intelligent skin. The processor may be configured to individually and independently control nutritional parameters for each environmental pixel, such as nutrient composition and concentration. For example, as shown in FIG. 13, a first or central region surrounding a seed may include nutrients with the following composition and concentration: 45% nitrogen (N), 20% phosphorous (P), 30% potassium (K) and 5% calcium (C). By contrast, regions further away from the seed, such as regions surrounding the central region may include different nutrient composition and concentration as follows: 5% N, 30% P, 20% K and 45% C. Nutritional parameters may be controlled by provision of nutrients to each seed through tubes from a remote nutrient source; nutrient storage bins located behind the respective seed storage bins; one or more 3D printers located in the arterial space or capsule interior periodically injecting nutrients (e.g., in the form of nutrient-infused hydrogels) into the matrix; or HPPTs programmed to slow-release nutrients over time, thus providing tunable nutritional parameters for each seed.

Biovoxel Examples

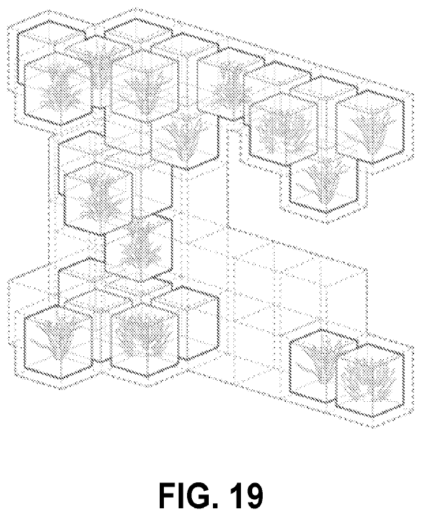

FIG. 14 shows a plurality of biovoxels in the shape of boxes of different sizes for accommodating plants of different sizes or at different stages of developments. As shown in the figure, the biovoxels may also including a petri dish rack for storing petri dishes and growing therein product such as plants in environmentally controlled racks, boxes or drawers that form an intelligent cell. The boxes may be located on racks or may be drawers slideable into walls of the capsule that surrounds and includes all the boxes or drawers. As exemplified in FIG. 14, the biovoxels may include narrow or wide low racks for petri dishes, medium-sized containers stored on racks, and large boxes for living plants or preserved specimens, which may be wall-mounted or floor-mounted. Alternatively, as exemplified in FIG. 19, the biovoxels may all have the same size and shape and be stackable to minimize space usage. The biovoxels in a capsule may all contain the same or different plants, or there may be multiple experiments running in a single capsule. In one embodiment, all of the biovoxels are rectilinear for efficient stacking, although they may be spherical, cylindrical, or have any shape or combination of shapes.

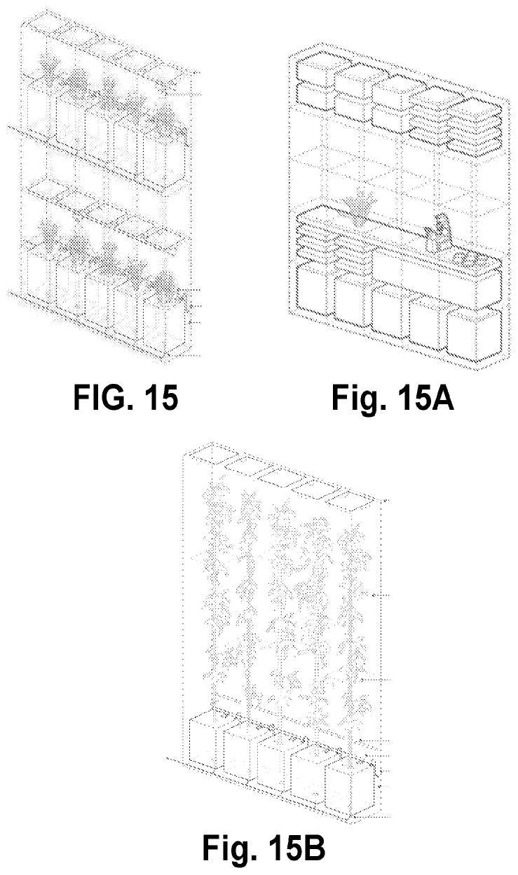

FIGS. 15-15B show further exemplifications of a matrix of biovoxel boxes and/or drawers in a growth capsule. Alternately or in addition to light provided by the pixelated walls of each intelligent cell, box or drawer that surround a plant, a modular light emitting diode (LED) grow light may be provided on a roof of each biovoxel. Further, a camera may also be provided on the roof to monitor the plant. Other monitoring sensors are also provided to monitor various factors. The camera and sensors provide information to the processor for control of various aspects of the biovoxels including control of the various factors such as pH, temperature, humidity, light, nutrients, water, drainage and/or air flow monitored by sensors configured to monitor and sense such parameters and provide the sensed information to the processor. As show in FIG. 15, water such as reverse osmosis (RO) water is provided by tubes under the control of the processor. Alternately or in addition, irrigation may be provided by use of pressure concentrated dripper and emitter, dripper sticks and the like. Further drainage tubes are connected to ports at the bottom of each container that includes growth medium such as soil, for example. Controllable actuating valves may be included along the path of tubes or channels to open and close under the control of the processor, such as to provide a desired amount of water and/or or allow a desired amount of drainage such in as in response to moisture in the soil as detected by a moisture sensor and such information provided to the processor to effectuate moisture control, such as by controlling actuating valves to provide water and/or drainage, as desired. Controllable actuating valves may also be included in an air channel to regulate air flow.

The sensors provide sensed signals to the processor to form a feedback loop. In particular, in response to the sensed signal(s), the processor controls individual environmental pixels of the pixelated walls/skin of the intelligent cell, as well as controls actuators and valves to control and adjust the environment of the biovoxels. For example, a humidity detector may detect humidity or moisture level in the air and provide a sensed humidity signal to the processor for controlling and adjusting the humidity to a desired level. Further, a light sensor(s) may detect light at various locations within the biovoxel and provides such signals to the processor for adjusting the light output from one or more of the environmental pixels of the pixelated walls/skin of the intelligent cell.

FIGS. 15A and 15B provide further embodiments of exemplary biovoxels and their arrangements. In FIG. 15A, the biovoxels are located at the top and bottom of the capsule, and a laboratory counter (furnished with a microscope in the illustrated embodiment) provides a convenient height for experimentation. FIG. 15B shows another exemplary embodiment comprising a set of high biovoxels which are useful for growing tall plants such as bamboo. The biovoxels comprise a growth medium, shown in the shape of a cube. The growth medium is serviced by reverse-osmosis water and tempered air, and drainage is provided at the bottom of each biovoxel. A modular LED growlight is provided at the top of the biovoxel and a sensor monitors the growing conditions. Bamboo grows along a support rising vertically in the biovoxel.

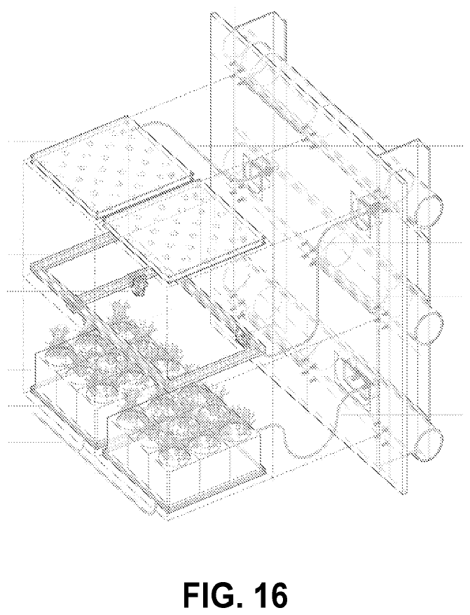

FIG. 16 shows another embodiment with a more detailed view of a matrix of biovoxels as a matrix of boxes and/or drawers in a growth capsule, similar to that shown in FIG. 15. The biovoxels illustrated in FIG. 16 are connected via cables or tubing to services located in the intelligent skin for entry of inputs such as water, air, and electrical power for powering lighting and sensors.

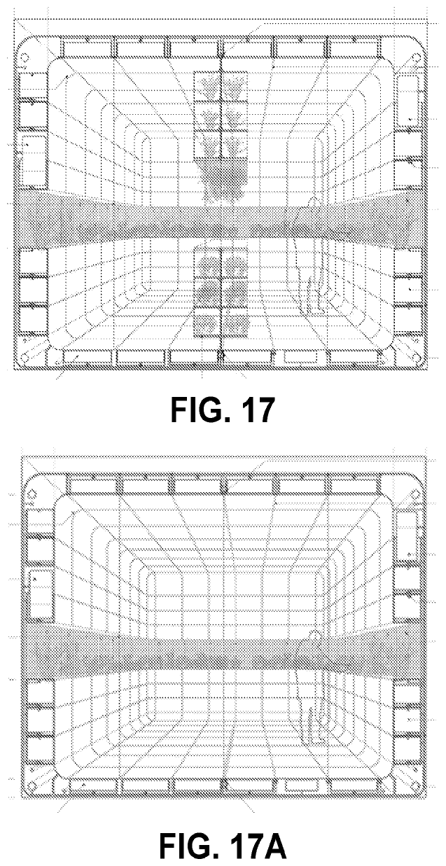

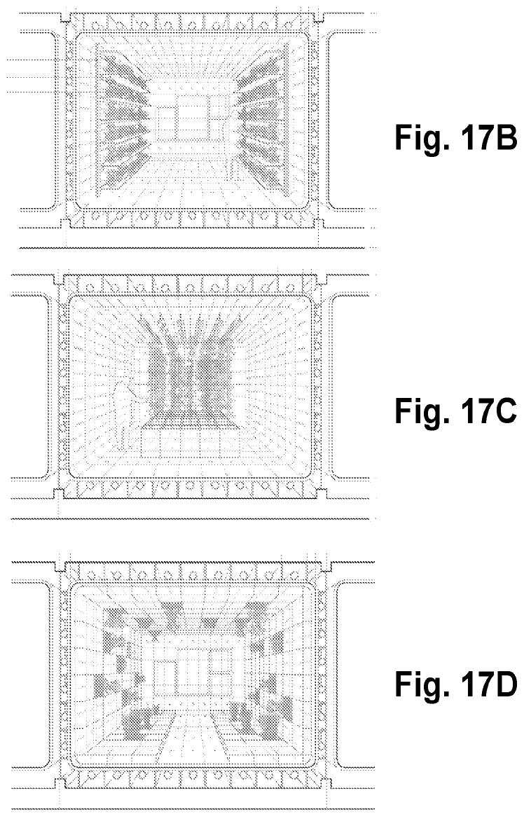

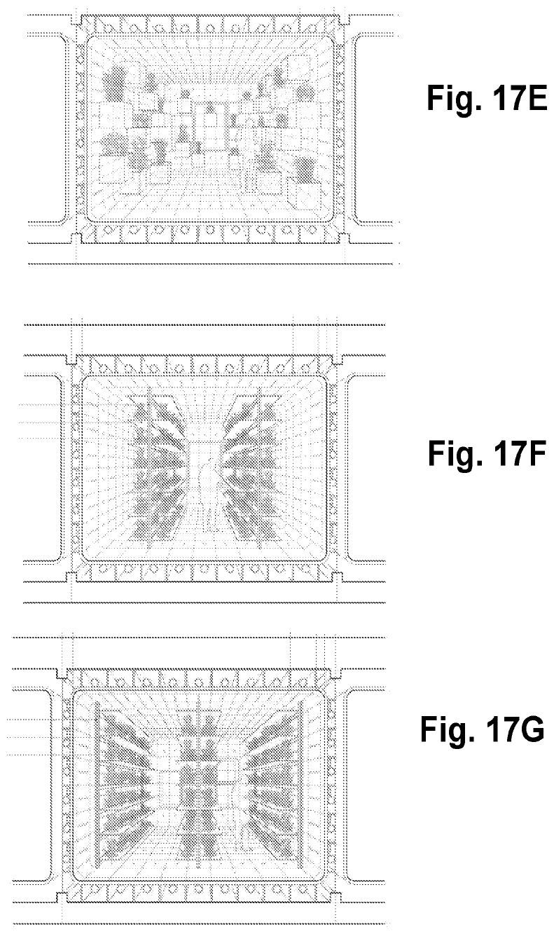

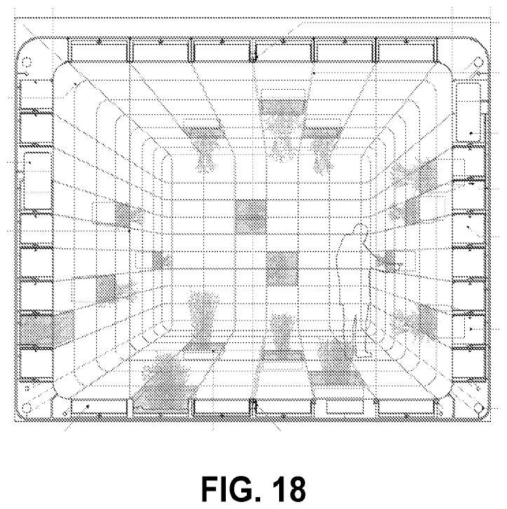

While a capsule may be configured to accommodate a single plant surrounded by the intelligent skin of the capsule, a capsule may also be configured to accommodate a plurality of plants and may be of any size, including large enough to provide workspace for humans. In such a case, a capsule may be viewed as large growth capsule which may further include smaller biovoxels, each with an intelligent skin that surrounds one or more plants. FIGS. 17-17G and 18 show exemplary embodiments of a large capsule that includes smaller biovoxels. These illustrated embodiments are approximately the dimensions of a room and permit a scientist to conveniently enter and conduct research. In other embodiments, a capsule may be installed in a part of an existing room or laboratory, for example, being mounted against a wall such as a bookcase or desk hutch, or in an interior location of the room or laboratory, for example, under a desk or lab bench. Tall biovoxels are suited for growing tall hybrid plant products such as cloth in which long fibers are desirable.

FIG. 19 shows individual biovoxels, each with an intelligent skin, that are stackable in a capsule.

In an illustrative embodiment of the present system, an environmentally controlled capsule is provided where various aspects of the capsule environment is controlled by a processor, such as temperature, humidity, light, airflow and irrigation, for example. In another illustrative embodiment of the present system, the capsule may or may not have a highly granular controlled environment and instead has individual and independent self-contained biovoxels, each with highly granular controlled environment where each biovoxel may be controlled to have its own desired environment. In another illustrative embodiment, the individual biovoxels may be configured to communicate with each other. Such controls may be provided by a processor, which may be a central processor alone or in combination with local processors (local to each biovoxel).

The processor(s) may control each specific pixel environment based on input received from sensor(s) associated with each specific environmental pixel. For example, when sensor(s)-1 of environmental pixel-A indicates an undesired environmental condition, such as too high a temperature, while sensor(s)-2 of environmental pixel-B indicates low humidity, then the processor(s) may reduce the temperature of environmental pixel-A and increase the humidity of environmental pixel-B. In addition to temperature and humidity control, other environmental conditions of the capsule and/or individual environmental pixels may be controlled, such as light, and airflow, for example. Based on sensor signals from one or more environmental pixels, and or communication among various environmental pixels, the processor may adjust environment and energy consumption of environmental pixels. For example, when the processor determines that plant-A in environmental pixel-A is healthier than plant-B in environmental pixel-B and plant-B may not recover, then the processor may be configured to divert environment and energy resources from environmental pixel-B to environmental pixel-A to further enhance plant-A. Alternatively, when the processor determines that plant-B may be re-energized and plant-A may continue to thrive with reduced resources, then processor diverts resources from environmental pixel-A to environmental pixel-B to re-invigorate plant-B. Thus, in one embodiment the processor is configured to recognize plant performance characteristics and further configured to channel resources to and from environmental pixels based on the plant performance characteristics. Such resources may include nutrients in addition to enhanced temperature, humidity, light, and airflow control. The following discussion provides exemplary embodiment of control of temperature, humidity, light, and airflow.

As described, a processor may be configured to independently and individually control each capsule to control various aspects of the capsule, such as the capsule's intelligent skin to vary and control various environmental factors of the capsule and the contained biovoxels, such as pH, temperature, humidity, light, nutrients, water, drainage and/or air flow. In one embodiment, the processor may be configured to execute instructions that may vary controls of the capsule's environment based on an autonomous Al-led learning algorithm, where learning is reinforced by responses and rewards to actions that favorably change a current state via a feedback loop. The processor may be configured to run a machine learning algorithm that learns which environmental factors provide optimal growth from observations of trial-and-error runs of changing environmental parameters and monitoring plant response thereto. For example, a feedback loop of stressors, rewards, priors, and mutations may be used to encourage an organism to achieve a particular goal, such as increased growth, increased production of fruit, augmented sequestering of carbon and/or other goals. Such Al-led learning algorithms may be referred to as genetic algorithms.

High Throughout Directed Evolution in Plants

A plant in the capsule may progress through its natural life cycle under observation and controlled environmental conditions. However, its life may also be actively directed on a timescale that is shorter than its natural lifetime and regulated by machine learning algorithms, for the purposes of high throughput directed evolution. For example, with a reinforcement learning paradigm, growing plants may be continually evaluated according to criteria aligned with a particular objective function, such as carbon sequestration or vaccine development. Plants that are determined to be unfit (e.g., fail to express the desire trait or marker of that trait) may be eliminated while plants that are determined to be fit will be rewarded with the ability to continue to reproduce. This cycle may proceed until a plant has been determined to have achieved optimal or sufficient fitness.

In an illustrative example, an array of plants is placed in biovoxels on the walls and floor of the capsule. These plants are all of a single species that was pre-selected based on its potential for exceptional photosynthetic efficiency, which drives the process of carbon sequestration. In the lab, scientists sequenced this specie's genome and regulatory genes linked to photosynthesis were tagged with green fluorescent protein (GFP). In the capsule, a robot mounted in the ceiling of the capsule monitors the plants in real-time as they grow within the controlled environment, periodically assessing which plants express the photosynthetic gene. The specimens that fluoresce are allowed to continue growing and reproducing; those that do not are killed or removed. Eventually, the capsule is filled with plants of optimal photosynthetic abilities. This development occurs over a time scale far shorter than would unfold in Nature. These plants may undergo further scientific study in the lab, or even be released into the wild to naturally propagate.

Growing a Product/Structure

Another objective function that the capsule may pursue is growth of products, structures, tangible goods, and building materials. Environmental conditions may be informed by a plant's typical behavior and conditions may be programmed to change over time such that the growing plant's final structure is form-found through its environmental conditions. For example, given that a plant tends to orient toward a light source, the positions and intensities of LED light sources may follow a programmed pattern that guides the stem into a coiled structure instead of a straight one. Extending this principle to smaller scales, as the bolls of a cotton plant begin to develop, environmental conditions may be programmed to direct cotton fibers to spin and weave themselves into a thread and then a sheet of fabric material. With enough environmental control, and potentially augmented by scaffolds (either static structures or structures that have been grown by other plants in the capsule) or interfacing equipment (such as a robotic loom), the cotton fibers may effectively be directed to grow a shirt or a shoe, thereby providing a hybrid plant product grown in a capsule according to the present invention.

In another example, bamboo is engineered to have a tunable amount of lignin based on small molecule inducers that are present or absent in its custom hydrogel growth medium during its development. More lignin will make it stronger and stiffer like a grown wall or beam; less lignin will make it more flexible and transparent like a grown window. In this way, bamboo can be grown to function as both a plant and a building material.

Cellular Automata

Environmental pixels and biovoxels may form relationships with their neighbors to gain a social intelligence by communication with neighboring environmental pixels/biovoxels. Such data may be used by the processor to optimize resources provide to the environmental pixels/biovoxels of different cells or capsules, where the processor may be configured to divert environment and energy resources from one cell to another cell, and/or from one environmental pixel of a cell to another environmental pixel of the same biovoxel. Further, pixel to pixel (or biovoxel to biovoxel, or cell to cell, referred to as cell for simplicity) communication leads to converting a cell without information or control, referred to as a vacant cell, as a converted cell namely converted from a vacant cell to a non-vacant cell, based on communication between and among adjacent cells, thus increasing the growing environment for a plant in a capsule surrounded by the cells.

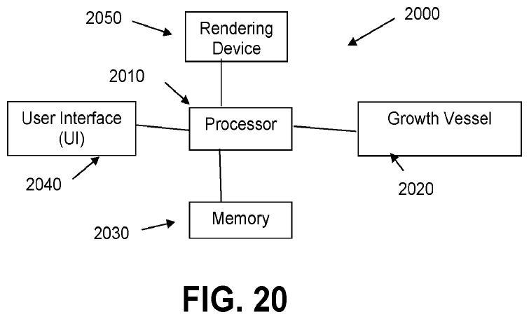

FIG. 20 shows a block diagram of a system 2000 according to an embodiment of the invention. As shown in FIG. 20, a processor 2010 is operatively coupled to a growth vessel 2020. The growth vessel 2020 may be a capsule (as described herein) with an intelligent skin including many biovoxels with their own intelligent skin. Alternately or in addition, the growth vessel 2020 may be an individual biovoxel having an intelligent skin. The growth vessel 2020 may also include various light sources such as LEDs incorporated in the environmental pixel of the intelligent skin or connected to the environmental pixels by light channels or fiber optic cables; sensors, such as pH, temperature, humidity, light, nutrients, water, drainage, irrigation and/or air flow sensors configured to measure environmental parameters in the growth vessel 2020; and actuators such as a fan, blower, pump, or valves which are configured to change environmental parameters in the growth vessel 2020.

As described above, the processor 2010 is configured to control the various environmental parameters in the growth vessel 2020 including controlling environmental pixels of the intelligent skin that surrounds and encloses an individual biovoxel, the intelligent skin of the capsule and/or the intelligent skin of each of the biovoxels or capsules included in the capsule. It should be understood that the capsule need not be environmentally controlled since the individual biovoxels are self-sufficient with controlled environments and may have their own individual sensors, actuators and processor.

Further, a memory 2030 is operatively coupled to processor 2010 and stores software modules, computer programs, algorithms or instructions when executed by the processor 2010, cause the processor 2010 to perform various operational acts to control and vary the environmental parameters in the growth vessel 2020. The memory 2030 may be further configured to store other instruction and data, such as Al learning algorithms and data monitored by the various sensors associated with or incorporated in the growth vessel 2020.

In addition, a user interface (UI) 2040 is operatively coupled to processor 2010 to allow user input, such as a keyboard, mouse, touch screen and the like. Further, a rendering device 2050, such as a display and or printer, may also be operationally coupled to the processor 2010 to output data and images (still or video) and provide output images of the biological matter or organisms growing in the growth vessel 2020 and/or provide (such as display or print) data of the monitored conditions in the growth vessel 2020 and/or status of the various actuators of the growth vessel 2020. In certain embodiments, the computer program product of the invention may be implemented in the form of an app for use by a portable computer such as a tablet, smartphone, or laptop; in the form of an application installed on a desktop or networked computer; or cloud-based as is known in the art. The app or application utilize a non-transitory computer readable storage medium which may be a magnetic disk such as a hard drive, an optical disk such as a CD or DVD, an electronic medium such as an SSD or USB drive, or other configuration for storing non-volatile data.

The various components of the system may be operatively coupled to each other via wired or wireless connections, such as Bluetooth™, Wi-Fi™ or any other radio frequency (RF) link, for example.

The processor 2010 may be a singular processor or a collection of distributed processors, such as having processors and/or controllers included with various system elements. For example, the growth vessel 2020 (including a plurality of biovoxels), the rendering device 2050, and UI 2040 may have their own dedicated processor that, collectively with other distributed processors of system 2000, are referred to as processor 2010 of system 2000.

Further, at least one of the elements of system 2000 may be operatively connected to a network, such as the Internet or a local area network, for communicating through the network with a remote server, a remote memory, a remote UI and/or a remote display, where the server may have its own processor, memory, UI and display as is well-known. All or some parts or elements of system 2000 may be connected to the network and server, directly or indirectly, though well-known connections, which may be wired or wireless, such as via wire cables, fiber optics, satellite or other RF links, or Bluetooth™. Similarly, the various elements of system 2000 may be interconnected, directly or indirectly, though well-known connections, which may be wired or wireless, such as via wire cables, fiber optics, Bluetooth™, as well as long range RF links such as satellite. Thus, processor 2010, memory 2030, as well as other elements of system 2000 shown in FIG. 20 may be co-located near each other, and/or may be remote from each other and operationally coupled or connected though a local area network and/or the Internet though wired or wireless secure connections where communications therebetween may be encrypted, for example.

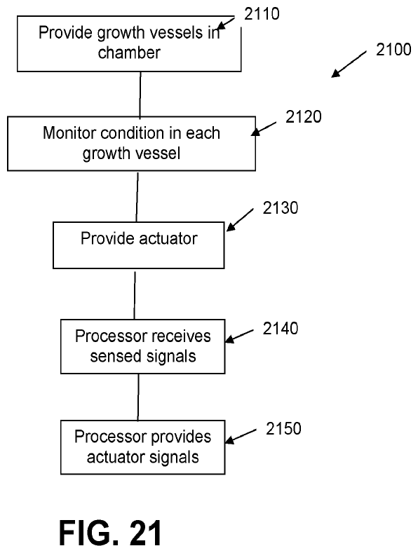

As illustrated in FIG. 21, a method 2100 according to the invention includes a step 2110 for providing growth vessels in a capsule, such as the growth vessels 2020 of FIG. 20 that includes or is operatively coupled to sensors and actuators, where each growth vessel is configured to surround the organism and to include material for the growth of the organism. Next in step 2120, at least one environmental condition in the growth vessel is monitored by at least one sensor configured to output sensed signals; and in step 2130, at least one actuator is provided. In step 2140, a processor (such as the processor 2010 shown in FIG. 20) receives the sensed signals and in step 2150, the processor provides to the at least one actuator actuation signals to actuate the at least one actuator to change the at least one environmental condition in response to the sensed signals.

The software modules, computer programs, instructions and/or program portions contained in the memory may configure the processor to implement the methods, operations, acts, and functions disclosed herein. The processor so configured becomes a special purpose machine or processor particularly suited for performing the methods, operations, acts, and functions. The memories may be distributed, for example, between systems, clients and/or servers, or local, and the processor, where additional processors may be provided, which may also be distributed or may be singular. The memories may be implemented as electrical, magnetic or optical memory, or any combination of these or other types of storage devices. Moreover, the term “memory” should be constructed broadly enough to encompass any information able to be read from or written to an address in an addressable space accessible by the processor. With this definition, information accessible through a network is still within the memory, for instance, because the processor may retrieve the information from the network for operation in accordance with the present system.

FIGS. 22A-22G show exemplary capsule representations having a modular configuration to accommodate multiple plants at a wide range of physical dimensions. FIGS. 22A and 22B show that the modular configuration of the grid infrastructure allows shelving to be placed as desired throughout the entire space. As illustrated in the figures, pixels or biovoxels can be placed along a wall, on shelving, or in other configurations. FIG. 22C illustrates that the architecturally integrated capsules can accommodate biovoxels of different heights for plants of various scales. FIG. 22D shows a loom used to augment the growth of hybrid living textiles inside a capsule. FIG. 22E shows cell or tissue laboratory equipment may be integrated into a capsule, while FIGS. 11A-11B have already shown that environmental conditions such as temperature (FIG. 11A), humidity (FIG. 11B), light (FIG. 11C), and airflow (FIG. 11D) can be integrated into a capsule. FIGS. 22F and 22G show representations of data and communications networks in the intelligent skin of the capsules.

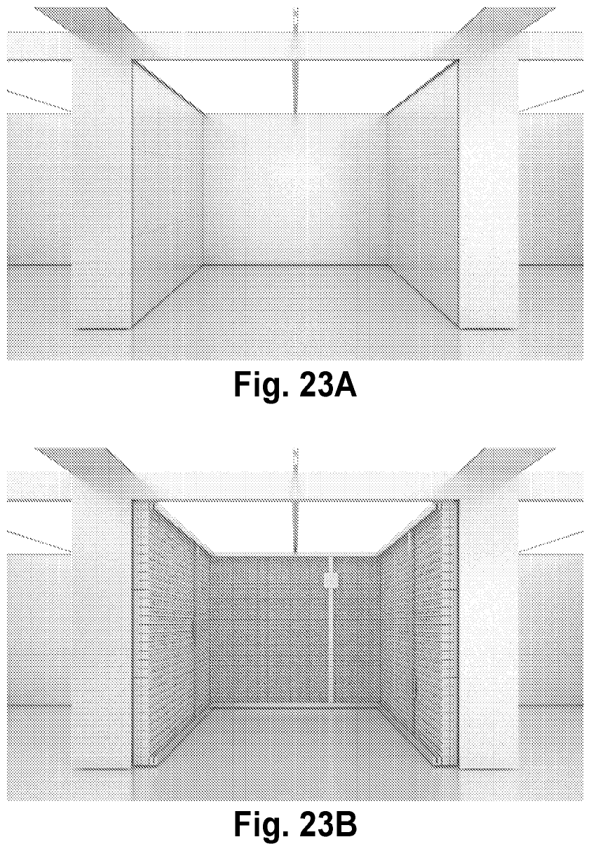

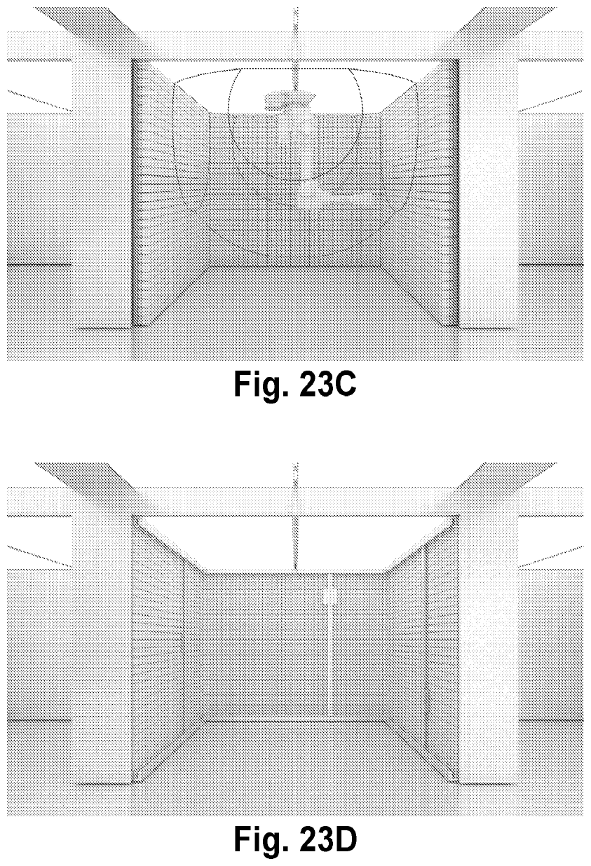

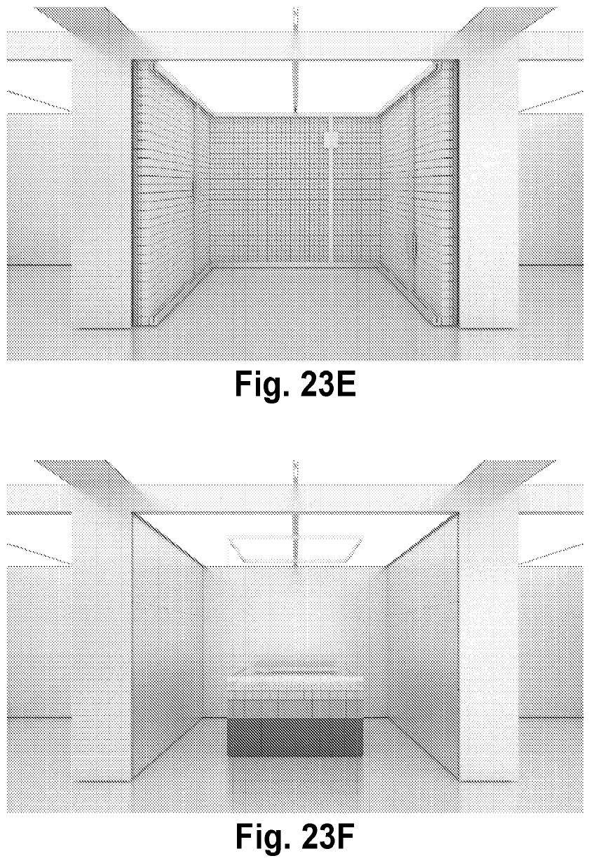

FIGS. 23A-23F illustrate exemplary capsule configurations with different wall, ceiling, and floor structure options. FIG. 23A shows a capsule with a “blank slate” configuration, in which infrastructure hookups for air, water, and other inputs are located behind removable panels. In an exemplary embodiment, the capsule walls are formed of 40-in×40-in (1 m×1 m) panels in a grid arrangement. These 40-in by 40-in panels can be subdivided into smaller cubes (representing biovoxels), for example into 4-in×4-in cubes (10 cm×10 cm) as shown in FIG. 23B. Airflow can be provided between the individual cubes or through a central air duct. In an embodiment, the cubes can be in the shape of a “sleeve”, in which the cube is open on two sides and contains the plant and growth substrate. In the illustrated embodiment, there are 36 40-in×40-in panels which in total comprise 3600 4-in×4-in cubes. Each cube is serviced by a custom XY gantry or the panel behind it.

FIG. 23C shows another embodiment of the cube grid concept illustrated in FIG. 23B, in which an industrial arm is mounted to the ceiling of the capsule and the arm is used to service each cube (biovoxel). In the flush bioreactor layer embodiment shown in FIG. 23D, a bioreactor or tech layer is fully embedded in the wall of the capsule. Custom robotic elements are used in conjunction with the bioreactor/tech layer to service each cube. FIG. 23E shows a capsule having a custom XY gantry installed on each of the three walls. The gantries may be custom-configured as appropriate to the needs of a particular project or implementation. FIG. 23F shows an embodiment of the invention, in which a bioreactor or tech layer is built as a table in the middle of the room. A custom XYZ gantry is suspended from the ceiling. In this embodiment, the smallest cubes are a 36×36 array of 1,024 parallelized experiments, and each cube is about 2.5-in×2.5-in (about 6 cm×6 cm).

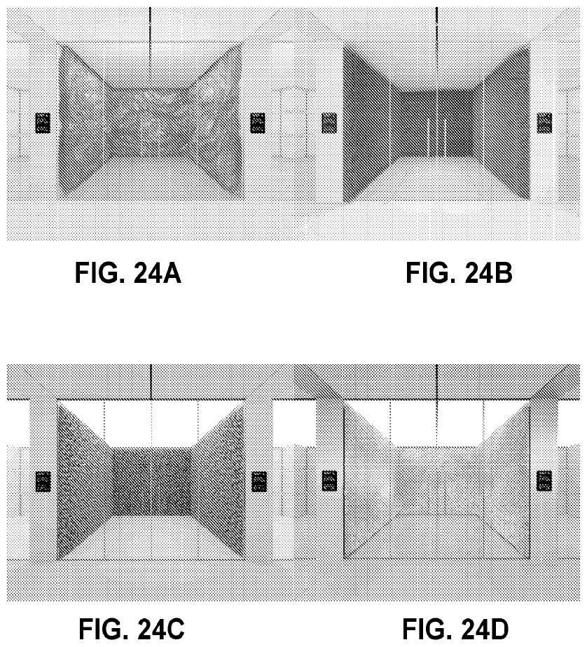

FIGS. 24A-24D illustrate additional exemplary capsule representations having different wall structure configurations to reflect different experimental requirements. FIG. 24A shows a biologically woven-type fabric similar to how a silk wall would create a protective film of silk. Such a wall is a type of protective coating that may modulate microenvironments in certain sections of the capsule wall. FIG. 24B depicts plants growing perpendicular from the wall surfaces in high density, and visualizes how a densely packed growth experiment may be conducted with small plants. FIG. 24C depicts a construction having tissue-like folds that provide high surface area and potentially regions of high/low humidity or high/low-light conditions defined by relative position on the geometric folds. FIG. 24D depicts a construction with compartments defined with a computational generative algorithm that simulates cellular automata like growth, and this construction evinces how such a capsule can be compartmentalized in a biologically relevant way instead of in a fixed grid.

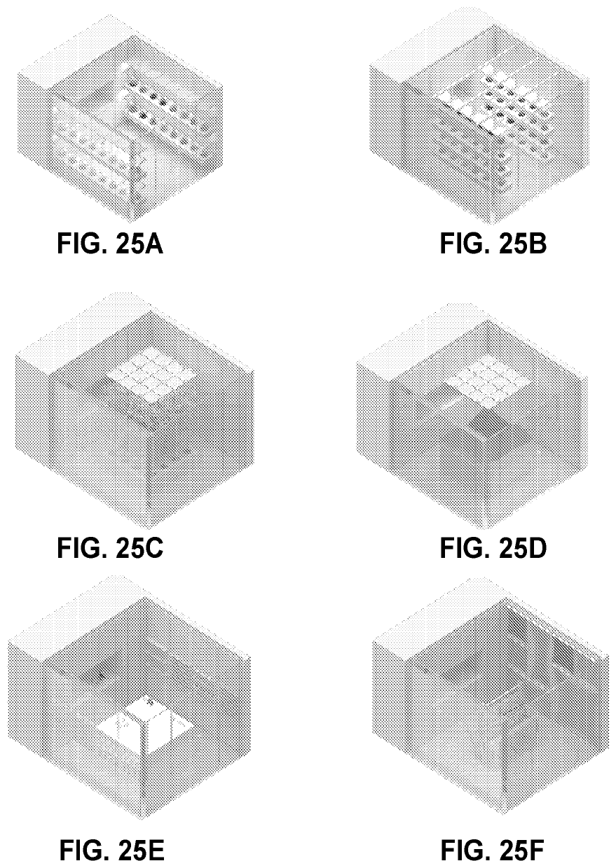

FIGS. 25A-25F are top perspective views of illustrative capsule embodiments. These embodiments show the use of hydroponics (FIGS. 25A and 25B), moss (FIG. 25C), optogenetics (FIG. 25D), cell or tissue culture (FIG. 25E), and hybrid living fibers (FIG. 25F) to provide different kinds of growth environments.

In addition to the room-sized capsules illustrated above, capsules may have smaller configurations. FIGS. 26A-26F show details of exemplary smaller capsules for growing plants in different environments. Specifically, FIG. 26A shows an exploded view of a basic mechanical setup of a smaller capsule in an unassembled state. The respective components are assembled to form the mechanical setup shown in FIG. 26B, which may further include irrigation services. Growing plants may be monitored using imaging modules such as a digital phenotyping camera (FIG. 26C). The camera may be a still camera that takes photographs at a particular time interval, or the camera may record video, as may be desirable for a particular implementation of the invention. In order to simulate growth in a zero-gravity or microgravity environment, a clinostat incorporating one or more biovoxels may be installed in a capsule, as exemplified in FIG. 26D. A clinostat is a device which uses rotation to negate the effects of gravitational pull on plant growth and development, and the resultant experimental data may be used to simulate plant growth in space or low-gravity environments. In further embodiments, a capsule may be integrated with a living liquid digital printer (FIG. 26E). In certain instances, it may found useful to grow plants in desired configurations as illustrated in FIG. 26F in which a cotton plant is grown directly into a textile.

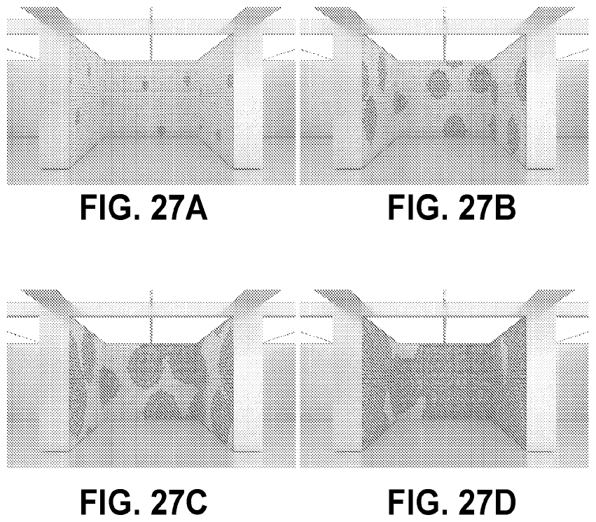

In certain embodiments of the invention, biovoxels have the opportunity to form relationships with neighboring biovoxels. FIGS. 27A-27D show biovoxels forming relationships with neighboring biovoxels to gain social intelligence. The category of cellular automata that is illustrated here is called excitable media, in which plants signal to neighboring plants, for example, using short or long range electrical communications.

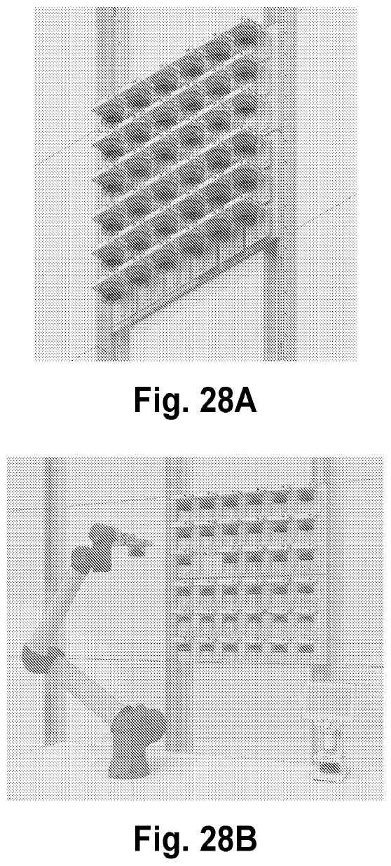

FIGS. 28A-28B show a matrix of biovoxels with clear vessels containing plants mounted to a capsule wall. The biovoxels may be manipulated using various devices, such as a robotic arm or gantry which can be installed on any suitable surface such as a tabletop, ceiling, or wall surface of a capsule. The biovoxels may receive inputs such as water and air from the intelligent skin or behind the wall of the capsule. As shown in other figures, biovoxels may alternatively be placed on shelves installed in the capsule.

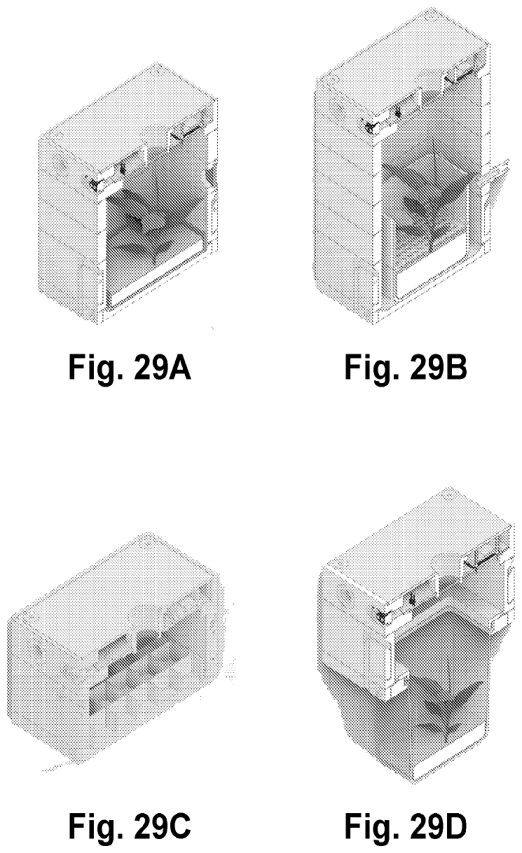

FIGS. 29A-29D illustrate exemplary embodiments of different kinds of biovoxels arrangements for use in growing plants. Certain experiments may wish to have plants share certain environmental inputs while varying other inputs. For example, air, humidity, and temperature can be shared, while lighting levels can be varied among each plant, and the embodiment of FIG. 29A exemplifies having certain environmental inputs in common while varying other inputs. In this embodiment, a sleeve is used for free air exchange while restricting light to only the amount provided in the experiment. The hydroponics pot and continuous fluid connections shown in the biovoxel of FIG. 29B can be used to run highly differentiated hydroponics experiments. The biovoxel shown in FIG. 29C contains a set of 25 compartments which can be used to run parallel experiments (for example, using petri dishes) within a controlled environment. In certain instances, it may be desirable to view or analyze the roots of a plant growing in a biovoxel. The biovoxel of FIG. 29D is made of clear polycarbonate to permit a researcher or computer system (e.g. using machine vision) to monitor a plant growing in the airtight sealed environment therein. Biovoxel embodiments can adopt a range of sizes, shapes, volumes, lengths, and features, as dependent upon the size of the contained organism. The biovoxels can be used for growing the hybrid plant products discussed above, in certain embodiments using hybrid plant product templates.

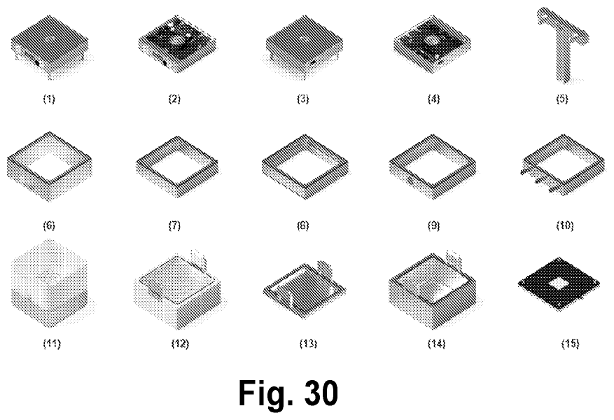

FIG. 30 shows a set of exemplary biovoxel components that can be mixed and matched into assemblies for the needs of an experiment. These exemplary components include top components such as a microcontroller (1), sensor (2), mounting plate (3), and porthole (4); a combined mechanical/electronic/data connector (5); middle components such as a quick-release latch sleeve (6), standard sleeve (7), open-air sleeve (8), septum sleeve (9), and fluid/gas quick connect sleeve (10); and bottom components such as a hydroponic pot (11), insect cage (12), standard base (13), deep base (14), and heating/cooling plate (15). As previously stated, these components can be combined in various suitable combinations to provide biovoxels for a particular experiment. The assembly components can be formed of any suitable material or combination of materials such as (but not limited to) aluminum or other metal, plastic, glass, ceramic, or composites. It is desirable for biovoxels to have a common footprint or interfaces to facilitate standardization of component parts. In one embodiment, biovoxels have a 125 mm×125 mm footprint and threaded connections or through-holes in corners or other appropriate locations

It is usually desirable to place electronics away from humidity sources, and in one embodiment, a biovoxel PCB provides an airtight seal to the capsule in addition to providing a surface for mounting of electronic components and lead lines. A biovoxel PCB will usually be located at the top of the biovoxel to minimize risk of water damage. Sensors such as for carbon dioxide, pressure, and temperature, as well as LED's that require exposure to the inside of a biovoxel may be placed on the “wet” side (inside or bottom side) of the PCB. Other components that do not require exposure to the interior of a biovoxel can be placed on the top side (or “dry” side) of the PCB. To provide increased flexibility, the biovoxel PCB design will typically have a standard header configuration so that sensors can be readily attached and detached from the PCB. To add new sensor capabilities to the system, a small sensor shield can be designed to fit into the main PCB header instead of designing a new PCB. A PCB will be networked to a central computer through a hardwired, wifi, or other RF connection to enable two-way communication with the biovoxel and for data and firmware updates as may be advisable.

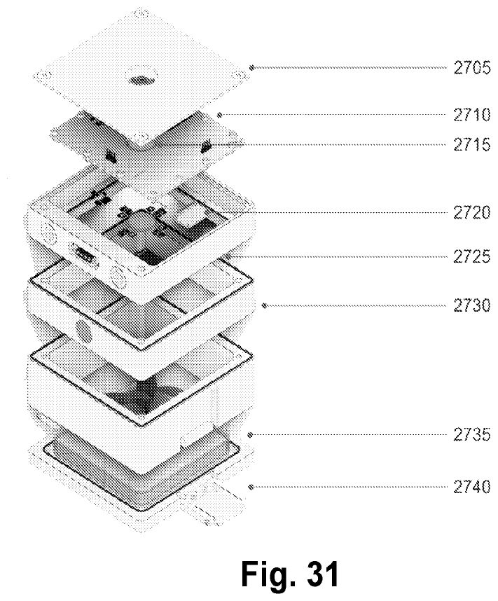

FIG. 31 shows an exemplary assembly of a biovoxel and its component parts. In general, each biovoxel assembly will have a top component, a middle component in the form of one or more sleeves, and a bottom component. The top component will typically house all of the primary electronics and the rack mounting hardware. The middle component may be one or more sleeves which are interchangeable and provide specialized functionality and additional height, while the bottom components will generally contain and provide the growth medium for the organism. The bottom components may include petri dishes, insect cages, hydroponics modules, soil, or other suitable structure. The bottom components typically contain a quick release latch to allow a scientist to open the biovoxel to load and unload material.

The exemplary embodiment of the biovoxel shown in FIG. 31 comprises a non-ferrous top plate (2705); a printed circuit board with an embedded microcontroller (2710), a glass surface for imaging (2715), and LEDs and sensors (2720) on the underside of the PCB; a main body (2725) for connections to the capsule for various inputs; a liquid/gas module (2730) with a pierceable septum for controlled entry of substances; a glass container (2735) for containing a growing plant; and a bottom cap with operable latch (2740) for opening the biovoxel from the bottom. The various components can be secured to each other using various kinds of connectors, such as snap connectors, screws or screw connectors, push-in connectors, male/female connectors, or other connectors as are known in the art.

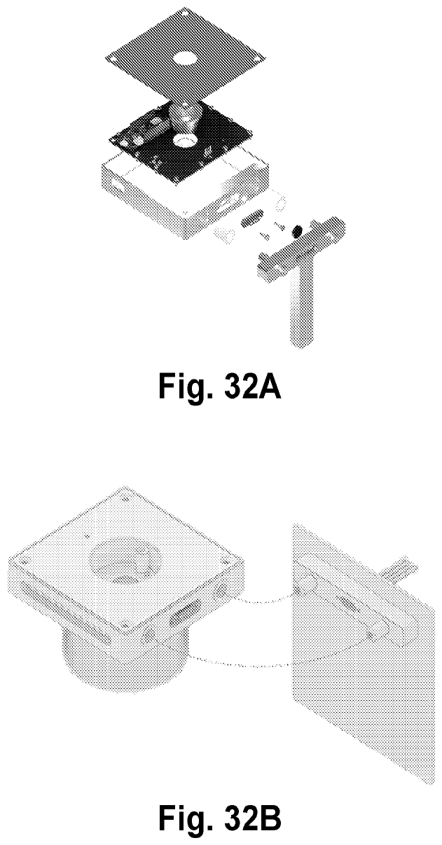

FIGS. 32A and 32B show connectors for attachment of a biovoxel to a capsule wall or intelligent skin according to an exemplary embodiment. In this embodiment, the illustrated top component houses all of the primary electronics and the rack-mounting hardware. Power and data connections in the top component are connected to the capsule wall through customized quick-connect hardware. Pins in the rack mounting hardware mate with the top component to thereby secure the entire biovoxel to a rack, shelf, or other mounting structure affixed to a capsule wall. Similarly, the data connector on the top component mates with the rack mounting hardware which itself mates with a data port of a biovoxel or capsule wall/intelligent skin to allow exchange of data communications between a computer (not shown) and each biovoxel. The capsules may be built using standard industrial design techniques. In an embodiment, the biovoxels are assembled and connected to capsule walls using finger-operable or hand-operable connectors such as thumb screws which avoid the need for specialized tools.

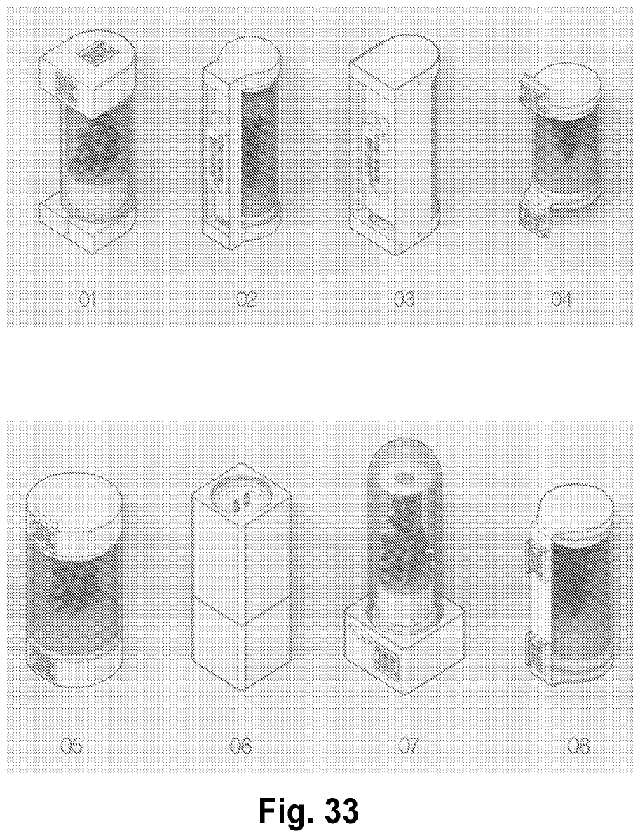

FIG. 33 shows exemplary embodiments of individual biovoxels having universal connectors for attachment to a capsule wall or intelligent skin. The use of a small number of universal connectors is intended to facilitate connection of biovoxels to a capsule wall or shelf and reduce the number of different interface connectors required. The universal connectors may provide a physical support connection to the capsule wall or a mounting rack, or the connectors can provide electrical power or data transmission, for example, an electrical connection for operating a light or heat source, or a data connection for exchange of electronic data or control signals. FIG. 33 also exemplifies placement of connectors to a mounting structure such as a capsule wall or mounting rack. For example, biovoxels can have connectors at their top (01 [two top connectors], 06), bottom (07), both top and bottom (04, 05, 08), or middle (02, 03). Other connectors are possible and within the scope of the invention.

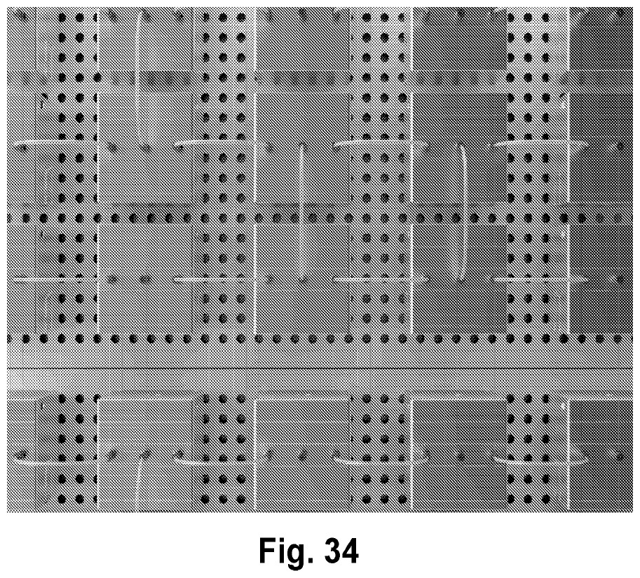

In certain embodiments of the invention, it may be desirable for individual biovoxels to exchange substances. FIG. 34 illustrates a set of wall-mounted biovoxels which are interconnected via tubing which may be used for exchange of gases, water, volatile compounds, and other substances between individual biovoxels, as dependent upon the particular implementation of the invention. This sharing of environmental inputs or plant-generated signals can be used for social intelligence or excited media cellular automata studies.

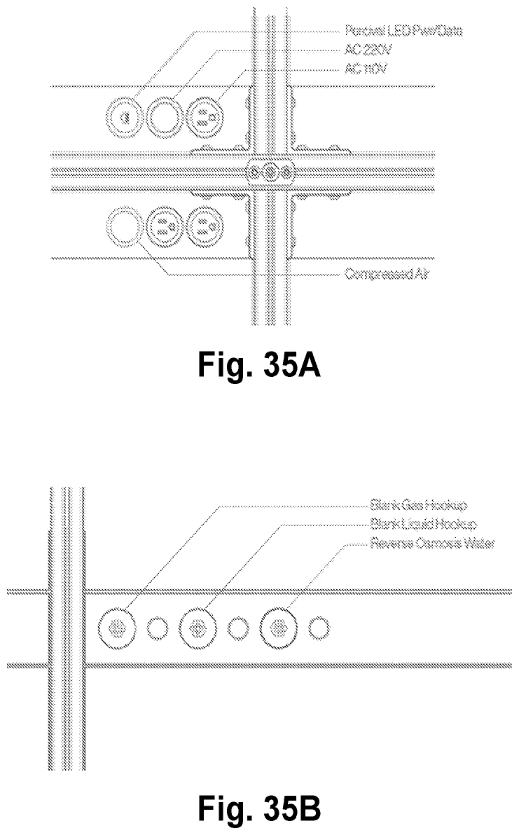

FIGS. 35A and 35B show exemplary embodiments of intrastructure connections for biovoxels to a mounting rack or capsule wall. The illustrated infrastructure connections include electrical power (110V, 220V, or Percival® LED power, or other suitable voltage or power connector), air (compressed air), water (reverse osmosis water or other aqueous fluid), although other types of inputs are possible and within the scope of the invention. Cables or tubing can be used to connect the infrastructure connections to the biovoxels.

Additional Exemplary Use Cases

In addition to the non-limiting examples described above, the following examples further illustrate the capabilities and advantages of the present invention:

Hyperaccumulators: Hyperaccumulating plants (e.g., Arabidopsis, Brassicaceae) may be used in a study of controlled evolution. For example, the plants may be arranged from youngest to oldest in biovoxel, growing in a clear synthetic medium that includes Au, Cd, Si, Cu, and Ni metal. The plants are imaged from above and below to monitor root and shoot changes using a digital phenotyping camera. Specific interventions can be applied with targeted heat, ultraviolet light, and/or targeted mutagenesis. The resultant product is a plant optimized for hyperaccumulation with quantified maps of metal accumulation in the leaf, root, and stem.

Accelerated Simulation: Aging simulations of candidate materials, plants, organisms architectural/building elements, and the like are possible using the present invention. Such materials can be exposed in the growth capsules of the present invention to an accelerated cycle of seasonal/weathering conditions simulating a particular location (e.g., Manhattan) and projected for a period of time, e.g., over the next ten years. This simulation can provide data in an accelerated manner, e.g., over the course of a week, as compared to studies in the natural environment, and the experimental results can inform computational simulation to define a library of materials and organisms.

Moss: The capsule floor of the present invention becomes a landscape dominated by Physcomitrella patens, Marchantia polymorpha and/or other similar moss or liverwort species. The moss or moss-like organism is grown in shallow trays with compacted acidic soil supplemented with nutrients, optimally in a darkened and humid capsule. As behavior such as chloroplast movement, phototropism, and stomata activity in this moss are influenced by the presence of blue and red light, LED lights of specific wavelengths are placed above the trays and are used to direct plant growth and behavior. The utility of such plant arrangement is in allowing for surface level directed evolution experiments such as those demonstrated by Butt, H et al. Genome Biology 20, 73 (2019).

Microgravity Environments: Plants may be grown in capsules in a microgravity environments to model agriculture in space. In an exemplary application, plants may be designed with artificially designed seed coats to modulate or control seed germination. Artificially designed seed coatings refer to coatings made from materials such as synthetic exosperms, hydrogels, deposits, and polymers that are not naturally occurring and that are placed as a secondary process on top of the endosperm or the natural exosperm of a seed to modulate or control seed germination, as discussed in Xi, L., et al, Advanced Materials, 2021. Such seeds may be planted within a clear medium and exposed to cycles of microgravity in capsules in a clinostat, a device which uses rotation to negate the effects of gravity on plant growth and development, enabling simulation of microgravity and off-Earth conditions such as lunar and Martian habitats. The exposure to microgravity will show if there is an influence to the production and function of chloroplasts, leading to the design of a generation of “space-ready” plants. The mechanisms behind the plant changes-in terms of metabolism, growth rate, tropisms—can be quantified. The resulting process can provide a new mode of “growth manufacturing” that uses the plant to mediate the formation of product in microgravity, creating unique hybrid living objects. Such research will add important information about plant growth to the scientific body of knowledge supporting astronaut health during spaceflight as well as emerging agriculture beyond the planet Earth. Additional information is provided by Karahara et al., Vegetative and reproductive growth of Arabidopsis under microgravity conditions in space. Journal of plant research, 2020, 133(4), pp. 571-585, and Stankovic et al., Plants in space. Into space: A journey of how humans adapt and live in microgravity, 2018, pp. 153-170.

Symbiotic growth: In an illustrative example, a capsule located in Manhattan, New York, which is located in USDA Hardiness Zone 7b, can simultaneously grow Brighamia insignis, a critically endangered plant native to the sea cliffs of Hawai'i (Zone 10), and Penstemon paydenii, an endangered plant found only in the Sandhills of Nebraska (Zone 4b) in separate biovoxels under their optimal environmental conditions. In this manner, plants having vastly different native growing environments can nevertheless be grown in close proximity using the present invention. These plants may also be co-cultivated in a single biovoxel, potentially enabling symbiotic relationships that would not naturally occur in the wild.

Algae: Algae in clear air permeable vials may be exposed to cycles of hypergravity (provided by centrifugation) and microgravity (provided by a clinostat). Each vial is imaged periodically using a standard camera. The images are processed to count the number of cells and monitor their morphology and health at regular intervals, allowing for correlation to the environmental conditions. As algae are autotrophs that can be engineered to provide biofuels and other useful compounds but are usually studied in bioreactors at 1g, such experiments will expand knowledge of their pattern of production and their range of products.

Circadian Rhythm: A capsule growing genetically engineered variants of the Maranta leuconeura prayer plant is programmed to lock into a macroclimate state of constant temperature and light for a given number of days, effectively eliminating all time cues. Standard cameras may be used to observe changes in the characteristic curling behaviors typically associated with the plant's circadian rhythm. Patterns may be identified between behavioral expressions and activation or deactivation of genes linked to the central oscillator.

Time: A biovoxel can be programmed to simulate the climate conditions of Ancient Rome at a resolution that cannot be achieved in nature or by other existing technologies, thereby permitting research into historical growth conditions for various organisms. In another example, a biovoxel can be programmed to simulate conditions of global warming (increased carbon dioxide, higher temperatures and humidity) on organisms on an accelerated time scale, thereby providing additional methods of modeling climate changes and potentially resulting in unique solutions or accommodations to climate change.

In summary, the present invention has a number of advantages over conventional methods of optimizing growing conditions for plants.

The capsules enable hierarchical control and customization of each microclimate contained within. The inventive capsules and their components offer interchangeability of parts and consistent operation, thereby increasing efficiency as users do not have to re-learn operational processes for different biovoxel types. The interchangeability also reduces the time and cost required to produce biovoxels, and multiple biovoxels can be serviced by the same input source, e.g., central HVAC and power grids. It is therefore facile to scale up the number of biovoxels in a particular architectural space.

Capsules may also be integrated into architectural spaces, and such integration increases ease-of-access and enables an efficient, multifunctional workflow between the capsules and other research facilities. By providing services through the capsule walls, leveraging standard architectural technologies, and having the ability to fully or partially construct a capsule onsite, the interior volume of the capsule may be substantially increased compared to existing growth capsules. This increased capsule growth volume, in turn, can enable an increase in the scale of plants that can be grown inside. Tall plants, such as bamboo, can therefore be readily grown as a result of easily-applied synthetic and growth modifications.

The grid infrastructure used to organize the biovoxels in a capsule provides spatial flexibility and efficiency, and interior configurations of the biovoxels can be quickly modified to accommodate various parameters such as (but not limited to) environmental conditions, sensor arrays, and interfacing equipment. Furthermore, an intelligent skin permits high-resolution environmental control across a 3D volume, and enables communication between different points, whether associated with an environment or with plants, and allows for intensive data collection.

In embodiments employing machine learning, the Al aspects of the invention allow for a higher throughput of natural selection and a higher throughput of scientific experimentation and consistent manufacture of HPPs, derived from an automated and closed feedback loop.

By appropriate use of a combination of a biovoxel, which enables the tuning of growth parameters, and a capsule, which enables control over spatial parameters, the invention enables high-resolution design of individual plants and environments. Further, this level of control enables a new level and velocity of experimental design with fully simulated growth conditions, high throughput, automation, and remote operation. One can program simulated growth conditions based on various climates spanning vastly different scales, time zones, and even off-Earth environments, regardless of where or when the capsule itself is located-in effect, providing a space-time machine.

It will be appreciated by persons having ordinary skill in the art that many variations, additions, modifications, and other applications may be made to what has been particularly shown and described herein by way of embodiments, without departing from the spirit or scope of the invention. Therefore, it is intended that the scope of the invention, as defined by the claims below, includes all foreseeable variations, additions, modifications or applications.

Finally, the above discussion is intended to be merely illustrative of the present invention and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system for regulating growth of an organism, the device comprising:
a growth capsule;
one or more biovoxels located in the growth capsule, each biovoxel being configured to surround the organism and to include material for the growth of the organism;
at least one sensor configured to monitor at least one environmental condition in each biovoxel and output sensed signals;
at least one actuator configured to be actuated in response to actuation signals; and
a processor configured to receive the sensed signals and output the actuation signals to actuate the at least one actuator to change the at least one environmental condition in response to the sensed signals.

2. The system of claim 1, wherein the organism is one of plants, algae and bacteria.

3. The system of claim 1, wherein the material includes at least one of soil, water, nutrients and air.

4. The system of claim 1, wherein the at least one sensor includes at least one of a pH sensor, a temperature sensor, a humidity sensor, a moisture sensor, an air flow sensor, a light sensor, a toxicity sensor, a gas analyzer sensor, a dissolved oxygen sensor, a carbon dioxide sensor, a color sensor, and an atmospheric pressure sensor.

4. The system of claim 1, further comprising a memory configured to store information of desired environmental conditions.

5. The system of claim 1, further comprising a display configured to output at least one of an image of the organism, information sensed by the at least one sensor, and a status of the at least one actuator.

6. The system of claim 1, wherein the actuator is selected from the group consisting of a fan, blower, pump, valve, and robot.

7. The system of claim 1, further comprising artificial intelligence for adjustment of the at least one actuator in response to the sensed signals.

8. The system of claim 7, wherein the artificial intelligence adjusts the environmental condition inside each biovoxel via a feedback loop.

9. The system of claim 1, wherein the growth capsule has an intelligent skin comprising one or more of an environmental sensor, microcontroller, camera, and infrastructure port.

10. The system of claim 1, wherein the intelligent skin comprises one or more of (a) a system of structural support; (b) provisioning of nutrients; (c) an irrigation system; (d) an airflow and humidity system; (e) temperature control; and (f) control of light.

11. The system of claim 1, wherein each biovoxel provides a self-contained growth microenvironment to the organism contained therein independently of adjacent biovoxels.

12. The system of claim 1, wherein each biovoxel is modular and comprises interchangeable components.

13. The system of claim 1, wherein at least one biovoxel comprises a microcontroller configured for communicating sensed signals from the sensor to the processor and receiving actuation signals to change the at least one environmental condition.

14. The system of claim 9, wherein the one or more biovoxels are mounted on a rack or shelf affixed to the intelligent skin.

15. The system of claim 1, wherein system comprises a clinostat for providing a microgravity environment to one or more biovoxels.

16. The system of claim 1, wherein the biovoxel comprises one or more components selected from the group consisting of a microcontroller, sensor, mounting plate, porthole, mechanical/electronic/data connector, sleeve, fluid connector, gas connector; hydroponic pot, and heating/cooling plate.

17. The system of claim 1, further comprising a robotic arm or gantry for servicing each biovoxel.

18. The system of claim 1, wherein selective biovoxels are interconnected to exchange one or more of gases, water, and volatile compounds.

19. The system of claim 1, wherein the one or more biovoxels are configured to grow a hybrid plant product.

20. The system of claim 1, wherein the one or more biovoxels are configured to grow an organism using a hybrid plant product template.

21. A method for regulating growth of an organism, the method comprising steps of:
providing biovoxels in a growth capsule, each biovoxel being configured to surround the organism and to include material for the growth of the organism;
monitoring at least one environmental condition in each biovoxel by at least one sensor configured to output sensed signals;
providing at least one actuator;
receiving the sensed signals by a processor; and
providing to the at least one actuator actuation signals by the processor to actuate the at least one actuator to change the at least one environmental condition in response to the sensed signals.

22. The method according to claim 21, wherein the actuation signals are provided by artificial intelligence.

23. A non-transitory computer readable medium storing computer instructions, which when executed by a processor, configure the processor to perform a method for regulating growth of an organism, the method comprising steps of:
providing biovoxels in a growth capsule, each biovoxel being configured to surround the organism and to include material for the growth of the organism;
monitoring at least one environmental condition in each biovoxel by at least one sensor configured to output sensed signals;
providing at least one actuator;
receiving the sensed signals by a processor; and
providing to the at least one actuator actuation signals by the processor to actuate the at least one actuator to change the at least one environmental condition in response to the sensed signals.

24. The computer readable medium according to claim 23, wherein the computer-readable medium is further configured for communicating with artificial intelligence for adjustment of actuation signals.
